(19) United States
(12) Patent Application Publication
(10) Pub. No.: US 2022/0373277 A1
(43) Pub. Date: Nov. 24, 2022

(54) HOVERING FIREARM SYSTEM FOR DRONES AND METHODS OF USE THEREOF

(71) Applicant: NEXT SNIPER LTD., Raanana (IL)

(72) Inventors: Boris KIPNIS, Tel Aviv (IL); Chen GOLAN, Ein Vered (IL)

(21) Appl. No.: 17/787,380

(22) PCT Filed: Dec. 18, 2020
(86) PCT No.: PCT/IL2020/051306

§ 371 Date: Jun. 20, 2022

(30) Foreign Application Priority Data
Dec. 19, 2019 (IL) 271579

(51) Int. Cl. F41A 1/10; B64D 7/06; F41A 19/13; F41A 19/58; F41G 3/16

(52) U.S. Cl. CPC F41A 1/10; B64D 7/06; F41A 19/13; F41A 19/58; F41G 3/16

(57) ABSTRACT

A recoilless firearm apparatus for firing at least one bullet of a respective standard cartridge, including a front barrel, a disposable firing activator and a rear discharge opening formed behind the front barrel and aligned with the longitudinal axis of the front barrel. The standard cartridge further includes a casing having an external diameter that is smaller than the rear cartridge-chamber diameter, wherein the casing encloses a sealed inner-casing space that contains gunpowder, and wherein the casing includes a primer. Upon activating the primer, the primer explodes to thereby detonate the gunpowder, forming propellant gasses inside the cartridge that are directed both forward and backward as follows: a) forward: firing of the bullet via the front barrel; and b) backward: pushing, by a recoil force Fₚ, the casing, being a counterweight to the bullet, to thereby eject the casing from the firearm apparatus via the rear discharge opening.

### FIELD OF THE INVENTION

The present disclosure relates to firearms and more specific to drone based recoilless firearm systems designed for small man-portable drones, including algorithms for controlling and aiming of the firearm attached to drone and methods to enable the firearm to operate recoilless, while using standard ammunition.

### BACKGROUND

In modern warfare, common, state-of-the-art lightweight drones and unmanned aerial vehicles (UAV) systems are widely used for reconnaissance. Only a small portion of the UAV systems are capable of carrying weapons, whereas these weaponized systems are usually large in size and can be subdivided into 2 main groups: (1) medium-altitude long-endurance UAV (MALE UAV) that can be equipped with several missiles (usually laser guided, for example “Hellfire”); and (2) suicide drones with single explosive head, whereas these weapons are lethal, very expensive and cause extensive collateral damage. Small firearms, on the other hand, have low collateral damage, but are not used with drones because of their high precision aiming requirements and their strong recoil force.

The idea of arming small drones has been around for a few years. In 2012, the U.S. Navy experimented with arming quadcopters with shotguns as counter-sniper weapons, but eventually they halted the project.

“Recoilless rifles” are a type of firearm known in art, but currently not mounted on drones. According to Wikipedia, “a recoilless rifle, recoilless launcher or recoilless gun is a type of lightweight artillery system that is designed to eject some form of counter-mass such as propellantgas from the rear of the weapon at the moment offiring, creatingforward thrust that counteract most of the weapon's recoil.”

All prior art “recoilless” systems are designed for a single shoot and use special purpose ammunition, for high caliber launchers, that were specially developed for that purpose.

The term “lightweight drone”, as referred to herein, is a drone that can be carried by foot soldiers.

The idea for using a gun or a sniper rifle attached to a “lightweight drone” is not quite applicable because of the recoil force formed during the shooting, which recoil force is applied to the drone and its components, and thereby pushes the drone far away from its original flying path and completely destabilize the guidance system including the gimbal(s) and the gun. Thereby, making it impossible to fire a second shot at the same target, right after firing the first shot.

Furthermore, when shooting from the air, it is typically required to aim downwards toward a target on the ground. As such, when shooting takes place, a lightweight drone is likely to flip over.

According to “Popular Mechanics”: https://www.popularmechanics.com/military/research/news/a27754/hobby-drone-sniper/, the article “When a Hobby Drone Becomes a Military Snipper” suggests a way of dealing with the firearm recoil by providing a special gimbal platform using some flexible plates.

In another article in “Business Insider”: http://www.businessinsider.com/a-us-defense-contractor-developed-a-sniper-drone-that-could-save-lives-2017-8, Duke Robotics Inc., the creators of the Tikad system 40, as depicted in FIG. 1, say that the Tikad has a unique suppression firing and stabilization solution. The weapon 42 is mounted on a robotic gimbal 44, which turns in real time, keeping its pointed aim in the desired direction. The recoil is distributed through flexible plates to minimize the overall effect, however, minimizing, but not eliminating, the recoil force.

The current Tikad prototype is complexed weigh around 50 Kilogram, and due to weight problems, it can stay airborne for about 5 minutes. Weapon 42 does not provide escaping that is equal and opposite reaction, and while the efficiency of Tikad system 40 as a gunnery platform remains unproven, it is well known that even in further versions the system is too heavy to be carried by single person or even a number of soldiers, while airtime duration remains very limited.

Successful attempts to couple a recoilless firearm system with a lightweight drone, in particular, without limitations, hovering drones such as quadcopter drones (also referred to herein as “multicopter drones”), are not known in the art. In particular, without limitations, recoilless firearm system for multicopter drones that are configured to shoot standard ammunition.

There is therefore a need, and it would be advantageous to provide “recoilless” firearm systems that fire standard ammunition known in art. Preferably, the system is a lightweight system that can be carried by single person, can be used repeatably and can typically stay in the air for at least 30 minutes.

### SUMMARY

The principal intentions of the present disclosure include providing a small, lightweight and mobile air-born robots to meet modern warfare needs. For example, drones that can access any locations by air and have the capacity to carry a firearm that can aim and fire multiple shots, with non-lethal or lethal capabilities. The drone system, including the drone and the firearm, should be a single-man-portable and have long enough operational time to be able to patrol and intercept terror attacks from individuals, military, drones, kites, balloons and the like.

In order to achieve these goals, the firearm system is designed to meet several requirements:
1) The firearm should be small and lightweight and attachable to a coupled man-portable drone.
2) The firearm should be able to operate, during the flight, wherein the firearm must be recoilless, or at least with substantial recoil reduction in order to prevent or at least minimize the effect of the firearm on the drone operation.
3) The firearm should be able to perform continuous shooting and facilitate automatic firing.
4) To reduce operational cost, the firearm system should be able to use standard, off-the-shelf ammunition designed for assault rifles and guns.

It should be noted that although the present disclosure describes several recoilless methods and firearm aiming mechanisms, the overall goal of the present disclosure is to provide a recoilless firearm system, where the firearm is attached to a coupled drone.

According to the teachings of the present disclosure there is provided a recoilless firearm apparatus for firing at least one bullet of a respective standard cartridge, including a front barrel having an inner-barrel-diameter and a rear cartridge-chamber; a disposable firing activator; and a rear discharge opening formed behind the front barrel, aligned with the longitudinal axis of the front barrel. The standard cartridge further includes a casing having an external diameter that is smaller than the rear cartridge-chamber diameter, wherein the casing encloses a sealed inner-casing space that contains gunpowder, and wherein the casing includes a primer.

Upon activating the primer, the primer explodes to thereby detonate the gunpowder, forming propellant gasses inside the cartridge that are directed both forward and backward as follows:
a) forward: firing of the bullet via the front barrel; and
b) backward: pushing, by a recoil force Fₚ, the casing, being a counterweight to the bullet, to thereby eject the casing from the firearm apparatus via the rear discharge opening.

The recoilless firearm apparatus further including a disposable firing pin, wherein the activating of the primer is performed by the firing pin hitting the primer, and wherein the disposable firing pin is ejected with the casing from the firearm apparatus via the rear discharge opening.

The disposable firing activator may be an electric contact configured to transfer electric power from a side located electrode to the primer to thereby activate the primer, wherein the disposable firing activator is ejected with the casing from the firearm apparatus via the rear discharge opening.

The disposable firing activator may be a firing pin, wherein the activating of the primer is performed by the firing pin hitting the primer, and wherein the disposable firing pin is ejected with the casing from the firearm apparatus via the rear discharge opening.

The disposable firing-pin may include: a) a pin-body having a body having a pin-front-end, being an open end, and a pin-rear-end; b) a pin disposed at the pin-front-end; and c) at least one pin-wing disposed at the pin-rear-end.

When in a cocked state, the standard cartridge rear is seated inside the cartridge-chamber and the pin is positioned in safe proximity to the primer. The firing pin is made of rigid materials, wherein the parts of the firing-pin, including the at least one pin-wing, are made of deformable or breakable materials, such that when applying an excess force Fₑ onto the at least one pin-wing, the at least one pin-wing deforms or breaks.

Optionally, the disposable firing-pin includes a pin-body having a body having a pin-front-end, being an open end, a frontal-body-section and a rear-body-section having a pin-rear-end with a larger diameter end. The disposable firing-pin may further include a pin disposed at said pin-front-end, wherein the larger diameter of the pin-rear-end is configured to seal the rear discharge opening.

Again, when in a cocked state, the standard cartridge rear is seated inside said cartridge-chamber and the pin is positioned in safe proximity to the primer. The firing pin is made of rigid materials, wherein at least said rear-body-section, including the larger diameter end, is made of deformable or breakable materials, such that when applying an excess force Fₑ onto said firing pin, the firing pin deforms or breaks.

The recoilless firearm apparatus may further include a piped bolt-hammering-unit, having a bolt-front-face and a bolt-rear-face, and includes a body having a bolt-inner-opening formed there within. The bolt-inner-opening is larger than the external diameter of the casing, allowing free longitudinal motion of the casing there inside. The pin-wings have a wing-span that is larger than the bolt-inner-opening, wherein when the firearm is in a cocked state, the bolt-front-face is positioned in safe proximity to the pin-wings. The activating of the primer is performed by applying a unidirectional forward force on the piped bolt-hammering-unit that pushes forward the disposable firing pin and, thereby, the pin activates of the primer.

Upon the activating of the primer by the pin of the disposable firing pin, the formed propellant gasses push the casing and the disposable firing pin backwards by the recoil force Fₚ, where Fₚ>>Fₑ, thereby upon the pin-wings hitting the bolt-front-face of the piped bolt-hammering-unit, the pin-wings deform or break, and thereby, the casing and the deformed disposable firing pin continue to move through the bolt-inner-opening and eject from the firearm apparatus via the rear discharge opening.

The recoilless firearm apparatus may further include a recoilless-cartridge-assembly, a ribbed bolt-hammering-unit and a unidirectional energy transfer mechanism.

The recoilless-cartridge-assembly includes a standard cartridge and a detonation assembly. The detonation assembly includes a cylindrical-envelope having an inner diameter, an external diameter, a front end and a rear end, wherein the front end operatively faces the front barrel. The detonation assembly further includes a cylindrical-envelope, a rear plug and a disposable firing pin.

Typically, the cylindrical-envelope has an inner diameter, an external diameter, a front end and a rear end, wherein the front end operatively faces said front barrel. The rear plug securely encloses the inner diameter of the rear end of the cylindrical-envelope. The disposable firing pin includes a pin-body, at least one wing having a wing-span diameter, wherein the wing-span diameter is larger than the inner diameter of the cylindrical-envelope, and a pin.

At least one through slits is formed in the cylindrical-envelope, one slit for each respective wing. Each of the slit extends from the front end of the cylindrical-envelope to the rear end of the cylindrical-envelope. The slits segment the cylindrical-envelope into separate peripheral segments, wherein the rear end of each peripheral segment is sloped, starting at a first rear corner at each of the peripheral segment, and ending at the other corner of that peripheral segment and at a predesigned distance from the rear end of the rear plug.

When the detonation assembly is operatively assembled, each slit accommodates the open end of a respective wing, wherein, when the recoilless-cartridge-assembly is operatively assembled, the detonation assembly embraces the primary casing of the primary cartridge unit.

The ribbed bolt-hammering-unit includes a piped body and at least one directing rib. The piped body includes an inner base-opening forming an inner wall, a front face; and a rear face. The at least one directing rib protruding inwardly from the inner wall of the inner base-opening, at a preconfigured location, wherein the at least one directing rib is adapted to operatively engage with the open end of a respective wing.

The unidirectional energy transfer mechanism is designed such that wherein the number of the peripheral segments, the number of the wings, the number of the slits and the number of the directing ribs are equal. The bolt-inner-opening is defined by the tips of the directing ribs. The unidirectional energy transfer mechanism is configured to allow the bolt-hammering-unit to move forward freely, and to controllably block the bolt-hammering-unit from moving backward. The unidirectional energy transfer mechanism is adapted to apply the forward motion of the bolt-hammering-unit. While moving forward, when each of the directing ribs of the bolt-hammering-unit meets the sloped rear ends of a respective peripheral segment. It should be appreciated that any motion limitation mechanism, known in art as a “breechblock locking mechanism”, can be used as a unidirectional linear motion to block rearward motion of the bolt-hammer-unit, while in a cocked state.

The method of operating the unidirectional energy transfer mechanism includes the steps of:
a) pivoting the detonation assembly until reaching the respective slits;
b) entering the respective slits until meeting the open end of each of the respective wings that stick out of the cylindrical-envelope; and
c) pushing the firing pin forward towards the primary primer,
wherein upon reaching the primer of the standard cartridge, being disposed inside the rear cartridge-chamber in a cocked state, the pin impacts the primer to thereby causing the primer explosion and detonation of the gunpowder inside the casing.

The recoilless firearm apparatus may further include a recoil compensator that is securely attached to the front barrel, adapted to operatively compensate for the difference in forces ΔF, between a recoil force Fₚ, and the sum of the excess force Fₑ, the weight of the casing and all parts of the firing-pin. The recoil compensator may be a muzzle-brake or a jet nozzle.

In some embodiments, the recoilless firearm apparatus further includes a piped bolt-hammering-unit and a unidirectional energy transfer (being a motion limiting mechanism). The piped bolt-hammering-unit includes a piped body and at least one groove formed in the front face, wherein the. The piped body includes a bolt-inner-opening, wherein the at least one wing has a wing-span diameter, and wherein the wing-span diameter is larger than the inner diameter of the piped body. The piped body further includes an external diameter, a bolt-front-face, and a bolt-rear-face. The at least one groove is adapted to respectively accommodate the at least one wing.

The unidirectional energy transfer is configured to allow the piped hammering-unit to move forward freely, and to controllably block the piped hammering-unit from moving backward.

The unidirectional energy transfer is adapted to apply the forward motion of the piped hammering-unit. While moving forward, the piped hammering-unit is configured to collect the disposable firing-pin, and wherein the at least one wings is seated inside the at least one groove, respectively.

Upon reaching the primary cartridge, being in a cocked state, the pin impacts the primary primer of the primary cartridge to thereby detonate the gunpowder inside the primary casing, forming propellant gasses that are directed forward and backward as follows:
forward: firing of the primary bullet via the front barrel; and backward: pushing the primary casing and disposable firing pin backward;
deforming the at least one wing of the disposable firing pin into the inner opening of the piped hammering-unit; and ejecting the primary casing and the disposable firing pin via the inner opening of the piped hammering-unit, while the unidirectional energy transfer mechanism prevents the piped hammering-unit from moving backward.

Optionally, the disposable firing pin is provided by a band magazine, and wherein a respective the firing pin is dispatched from the band magazine by the moving forward piped hammering-unit.

The unidirectional energy transfer mechanism controls the motion of the bolt-hammering-unit, and wherein the motion may be a linear motion, a rotational motion or a combination thereof.

In some embodiments of the present disclosure, the recoilless firearm apparatus further includes a recoil-prevention mechanism, wherein the recoil-prevention mechanism includes a rear barrel, having the rear discharge opening, and a dual-cartridge firearm magazine. The dual-cartridge firearm magazine is configured to receive the standard cartridge, and a counterweight having a primer activator. the standard cartridge and the secondary cartridge are arranged in a back-to-back configuration.

The primer activator is operatively placed between the primer of the primary cartridge and the counterweight, such that the primer activator is aligned with the primer. The bullet of the primary cartridge is configured to be fired via the front barrel and the secondary cartridge is configured to be fired via the rear barrel. Upon detonation of the primary cartridge and, the generated recoil force pushes the casing and the counterweight rearwardly, to thereby eject the casing and the counterweight from the firearm apparatus via the rear discharge opening.

Optionally, the dual-cartridge firearm magazine is an electronic dual-cartridge firearm magazine having a high voltage module, wherein the primary cartridge is a combat cartridge, and the counterweight is an electronic cartridge, wherein the electronic cartridge includes:
a) a built-in, electric ignition circuit;
b) an electronic ignition heater;
c) a secondary casing;
d) gunpowder;
e) a firing activation unit; and
f) a sealing unit configured to seal the rear side of the electronic cartridge, wherein the sealing unit that also serves as a counterweight,

Upon receiving an electronic ignition trigger by the high voltage module, the dual-ignition electric circuit is activated to thereby turn on the electronic ignition heater and thereby:
a) detonating the gunpowder disposed inside the electronic cartridge;
b) shifting forward of the electronic cartridge towards the primary casing;
c) detonating the primary primer by the firing activation unit;
d) firing of the primary bullet via the front barrel;
e) ejecting the counterweight via the rear barrel.

It should be appreciated that the sealing unit and the propellant gasses serves as a counterweight to the weight of the primary bullet.

According to the teachings of the present disclosure there is provided a hovering firearm system including a hovering subsystem configured to lift a recoilless firearm apparatus to the air and fly towards a designated target, and a mounting platform, wherein the recoilless firearm is securely attached to the mounting platform. Upon firing the at least one bullet, the remaining residual recoil force allows the hovering firearm system to continue a controlled flight.

Optionally, the platform includes a first gimbal having a carrying face, and wherein the recoilless firearm apparatus is mounted on the first gimbal.

Optionally, the hovering firearm system further includes an electro-optical module having a camera, wherein the camera has an optical line of sight aimed to the target.

Optionally, the electro-optical module is attached to the first gimbal.

Optionally, the hovering firearm system further includes a second gimbal, wherein the second gimbal is independent of the first gimbal, and wherein the electro-optical module is attached to the second gimbal. The second gimbal may be independent of the first gimbal, and optionally, the second gimbal is mounted on the first gimbal.

The optical line of sight may be controllably aligned with the recoilless firearm to thereby facilitate sequential shootings at the target without losing the boresight.

The aligning of the optical line of sight boresight (boresighting) may be either mechanical alignment or electronic boresighting utilizing shift or image crosser motion.

Optionally, the boresighting includes locking of the line of sight on the target, and controllably aligning the longitudinal axis of the front barrel with the optical line of sight of the camera.

Optionally, the boresighting is updated in real-time using ballistic calculations, wind vector calculations or a combination thereof.

According to aspects of the present disclosure, there is provided a bidirectional recoilless firearm apparatus for firing at least one bullet of a respective standard cartridge having a standard caliber. This recoilless firearm includes a front barrel having an inner-barrel-diameter and a rear cartridge-chamber having a rear cartridge-chamber diameter configured to receive the standard cartridge; a disposable firing activator; and a recoil-prevention mechanism, wherein the recoil-prevention mechanism includes a rear barrel, having the rear discharge opening, and a dual-cartridge firearm magazine. The dual-cartridge firearm magazine is configured to receive the standard cartridge, being a primary cartridge, a secondary cartridge, and a dual firing pin unit having a primary pin and a secondary pin. The secondary cartridge includes a secondary sealed casing that includes gunpowder and a secondary primer, wherein the primary cartridge and the secondary cartridge are arranged in a back-to-back configuration.

The dual firing pin unit is operatively placed between the primer of said primary cartridge and the secondary primer, such that the primary pin is aligned with the primer of the primary cartridge and the secondary pin is aligned with the secondary primer. The bullet of the primary cartridge is configured to be fired via the front barrel and the secondary cartridge is configured to be fired via the rear barrel. Upon simultaneous detonation of the primary cartridge and, the recoil force generated by the secondary cartridge cancels the recoil force generated by the primary cartridge.

Optionally, the primary cartridge and the secondary cartridge are of identical type, wherein the front barrel and the rear barrel are not equal in length, and wherein upon simultaneous detonation of the primary cartridge and, the recoil force generated by the secondary cartridge cancels the recoil force generated by the primary cartridge.

Optionally, the recoil-prevention mechanism further includes a recoil compensator, to thereby compensate for inequalities between the recoil forces generated by the primary cartridge and the secondary cartridge.

Optionally, the primary cartridge and the secondary cartridge are not of identical type, wherein the front barrel and the rear barrel are not equal in length. Upon simultaneous detonation of the primary cartridge, the recoil force generated by the secondary cartridge cancels the recoil force generated by the primary cartridge. Preferably, the recoil-prevention mechanism further includes a recoil compensator, to thereby compensate for inequalities between the recoil forces generated by the primary cartridge and the secondary cartridge.

Optionally, the primary cartridge is a combat cartridge, and the secondary cartridge is a dummy cartridge. The recoil compensator may be a muzzle-brake or a jet nozzle.

According to the teachings of the present disclosure there is provided a recoilless-cartridge-assembly including a standard cartridge and a detonation assembly. The detonation assembly includes a cylindrical-envelope having an inner diameter, an external diameter, a front end and a rear end, wherein the front end operatively faces the front barrel. The detonation assembly further includes a cylindrical-envelope, a rear plug and a disposable firing pin.

The rear plug securely encloses the inner diameter of the rear end of the cylindrical-envelope. The disposable firing pin includes a pin-body, at least one wing having a wing-span diameter, wherein the wing-span diameter is larger than the inner diameter of the cylindrical-envelope, and a pin. At least one through slits is formed in the cylindrical-envelope, one slit for each respective wing. Each of the slit extends from the front end of the cylindrical-envelope to the rear end of the cylindrical-envelope. The slits segment the cylindrical-envelope into separate peripheral segments.

Optionally, the rear end of each peripheral segment is sloped, starting at a first rear corner at of each peripheral segment, and ending at the other corner of that peripheral segment and at a predesigned distance from the rear end of the rear plug. When the detonation assembly is operatively assembled, each slit accommodates the open end of a respective wing, wherein, when the recoilless-cartridge-assembly is operatively assembled, the detonation assembly embraces the primary casing of the primary cartridge unit. The rear end of each of the sloped peripheral segment may include two slopes, each leading towards a respective neighboring slit.

### BRIEF DESCRIPTION OF THE DRAWINGS

The present invention will become fully understood from the detailed description given herein below and the accompanying drawings, which are given by way of illustration and example only and thus not limitative of the present disclosure, and wherein:

FIG. 1 illustrates a non-recoilless, prior art Tikad system.

FIG. 2 is a top perspective view illustration of an example hovering firearm system, according to aspects of the present disclosure, the firearm system including a single gimbal.

FIG. 3a is a top perspective view illustration of an example hovering firearm system, according to aspects of the present disclosure, the firearm system including two independent gimbals.

FIG. 3b illustrates a controlled trigger-delay scheme for the firearm system of FIG. 3a.

FIG. 4 is a top perspective view illustration of an example hovering firearm system, according to aspects of the present disclosure, the firearm system including two interdependent gimbals.

FIG. 5a illustrates a top, partial cross-section view of a dual-cartridge assembly, according to aspects of the present disclosure.

FIG. 5b illustrates a top, partial cross-section view of one example embodiment of the dual-cartridge assembly shown in FIG. 5a, wherein the dual-cartridge assembly is utilized as a symmetric dual-cartridge assembly.

FIG. 5c illustrates a top, partial cross-section view of one example embodiment of a recoilless firearm utilizing the dual-cartridge assembly shown in FIG. 5a, wherein the dual-cartridge assembly is utilized with a first asymmetric dual-cartridge assembly.

FIG. 6a illustrates a top, partial cross-section view of a dual-cartridge assembly, according to aspects of the present disclosure, wherein the dual-cartridge assembly is utilized as a dual-cartridge assembly, and wherein the secondary cartridge contains an electric, dual-ignition circuit.

FIG. 6b illustrates a top, partial cross-section view of one example embodiment of a recoilless firearm utilizing the second asymmetric dual-cartridge assembly shown in FIG. 6a.

FIG. 7 illustrates a cross-section view of a portion of a firearm, showing the principles of a counter-mass mechanism, according to aspects of the present disclosure.

FIGS. 8a-8d illustrate, in a partial cross-section views, an example structure and the firing steps of using an example disposable firing pin to bring about detonation and the chain of events involved.

FIG. 9 illustrates a partial cross-section view of a portion of another firearm, showing the principles of another counter-mass mechanism, according to aspects of the present disclosure.

FIG. 10a illustrates a unidirectional energy transfer mechanism, according to aspects of the present disclosure.

FIGS. 10b and 10c illustrate another example of a unidirectional energy transfer mechanism, according to other aspects of the present disclosure.

FIG. 11a is an exploded view illustration of an example recoilless firearm system thatutilizes the methodology illustrated in FIG. 8.

FIG. 11b is an exploded view illustration of an example recoilless firearm system that utilizes the methodology illustrated in FIG. 8.

FIG. 12 illustrates an example unidirectional energy transfer mechanism, according to aspects of the present disclosure.

FIG. 13a illustrates an example recoilless-cartridge-assembly, according to aspects of the present disclosure.

FIG. 13b is in an exploded view of the recoilless-cartridge-assembly illustrated in FIG. 13a.

FIG. 14a illustrates the piped bolt-hammering-unit moving linearly forward with respect to the respective firearm, towards recoilless-cartridge-assembly, as illustrated in FIG. 13a.

FIG. 14b illustrates the piped bolt-hammering-unit moving linearly forward with respect to the respective firearm, towards another variation of a recoilless-cartridge-assembly, according to aspects of the present disclosure.

FIG. 15a illustrates a partial cross-section view of unidirectional energy transfer mechanism implemented using a blow-forward type recoilless firearm with a primer ignition, wherein the barrel return mechanism includes a barrel unit and a bolt assembly, according to aspects of the present disclosure.

FIG. 15b illustrates a partial cross-section view of the blow-forward type firearm shown in FIG. 15a, at the detonation state.

FIG. 15c illustrates a partial cross-section view of a variation of the blow-forward type firearm shown in FIGS. 15a and 15b, wherein the primer ignition utilizes a hammer assembly that includes a barrel unit, a bolt assembly and a hammer, according other aspects of the present disclosure.

FIG. 16 illustrates another an example of a recoilless firearm system having a recoilless cartridge and feeding mechanism, according to aspects of the present disclosure.

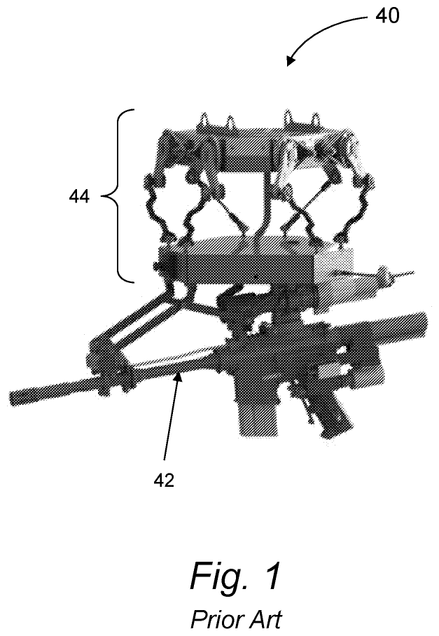

### DETAILED DESCRIPTION

The present disclosure will now be described more fully hereinafter with reference to the accompanying drawings, in which preferred embodiments of the disclosure are shown. This disclosure may, however, be embodied in many different forms and should not be construed as limited to the embodiments set forth herein; rather, these embodiments are provided, so that this disclosure will be thorough and complete, and will fully convey the scope of the invention to those skilled in the art.

An embodiment is an example or implementation of the disclosures. The various appearances of “one embodiment,” “an embodiment” or “some embodiments” do not necessarily all refer to the same embodiment. Although various features of the disclosure may be described in the context of a single embodiment, the features may also be provided separately or in any suitable combination. Conversely, although the disclosure may be described herein in the context of separate embodiments for clarity, the disclosure may also be implemented in a single embodiment.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the disclosures. It is understood that the phraseology and terminology employed herein are not to be construed as limiting and are for descriptive purpose only.

Meanings of technical and scientific terms used herein are to be commonly understood as to which the disclosure belongs, unless otherwise defined. The present disclosure can be implemented in the testing or practice with methods and materials equivalent or similar to those described herein.

It should be noted that orientation related descriptions such as “bottom”, “up” “upper”, “down”, “lower”, “top” and the like, assumes that the associated item, such as the firearm system or a portion thereof, is operationally situated.

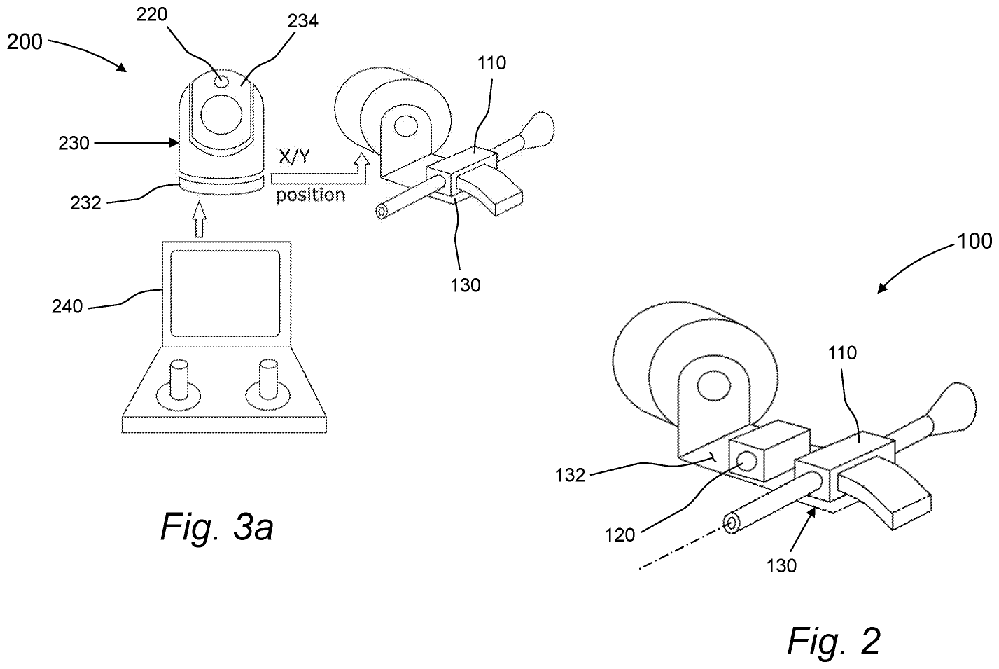

Reference is made back to the drawings. FIG. 2 illustrates an example hovering firearm system 100, having a single gimbal 130 with one or more axes, according to aspects of the present disclosure. Firearm system 100 further includes a firearm 110 and an electro-optical (EO) module 120. In this embodiment, firearm 110 and EO module 120 are attached, with no limitations, to same carrying face 132 of gimbal 130, wherein EO module 120 includes a camera having an optical line of sight, which is boresight with firearm 110. It should be noted that gimbal 130 can have one or more axes of motion.

It should be further noted that terms “boresight” or “boresighting”, as used in this disclosure, refer to methods of adjustment made to an optical line of sight, coupled with a firearm barrel, to align the firearm barrel with the optical line of sight. The boresighting between firearm 110 and electro-optical module 120 can be done using mechanical boresighting or electronic image shift/crosser motion, wherein the electronic boresighting may be updated in real-time using ballistic calculations, wind vector calculations or both.

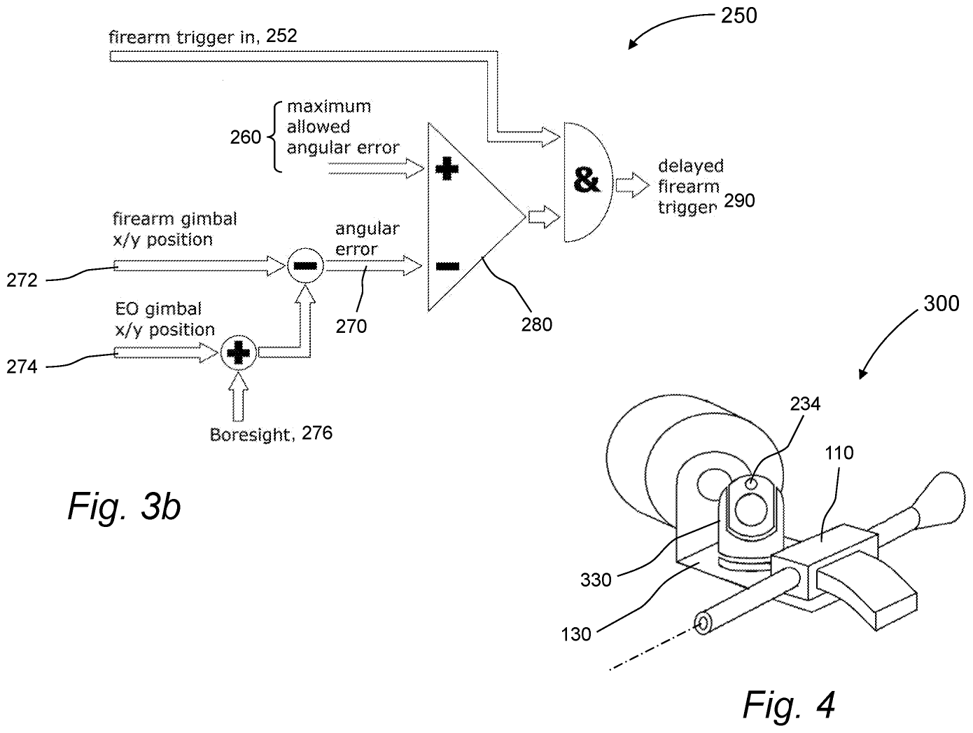

Reference is now made to FIG. 3a, showing a top perspective view illustration of another example of a hovering firearm system 200, according to aspects of the present disclosure, wherein the firearm system 200 includes two independent gimbals. Firearm 110 is still attached to gimbal 130, while EO module 120 is attached to gyro-stabilized gimbal 234. Both gimbals 130 and 234 can have one or more axes of motion, wherein both gimbals 130 and 234 are mounted on common platform (not shown), for example a drone. The present invention will be described herein, with no limitations, the term “common platform” being a drone, but the common platform can be, within the scope of the present invention, any moving platform.

The steering signals from a control unit 240 are used to control the EO gyro-stabilized gimbal 234, wherein the position report signals of EO gyro-stabilized gimbal 234 are used to control the firearm gimbal 130, to thereby allow both gimbals to reach the same angular positioning, where both gimbals 130 and 234 are pointing to the same target within predefined error range/envelop.

Reference is also made to FIG. 3b, illustrating a controlled trigger-delay scheme 250 for firearm system 200. Preferably, the optical line of sight of the EO module 120, being attached to gyro-stabilized gimbal 234, is controlled by EO control unit 240, wherein gimbal 234 is predesigned to be fast enough to provide the user with real-time stabilized image, while firearm gimbal 130 may have slower response and may use a different motor type to provide firearm aiming, being a heavier unit.

Once a trigger pulse 252 is sent to control unit 240, the firearm triggering is delayed until both gimbals—firearm gimbal 130 and EO gyro-stabilized gimbal 234 are pointing to the same target within predefined error envelop 260. The angular error 270 between firearm 110 and EO module 120 is calculated and compared with the maximum allowed angular error 260. The angular error 270 is calculated from the X/Y positions signal 272 of firearm gimbal 130, to which the firearm barrel is coupled, and the X/Y positions signal 274 of EO gyro-stabilized gimbal 234, to which the optical line of sight of the EO module 120 is coupled. If angular error 270≤maximum allowed angular error 260, the firearm trigger pulse is forwarded to firearm 110. Else boresighting shift between firearm gimbal 130 and EO gyro-stabilized gimbal 234, continuous, until angular error 270≤maximum allowed angular error 260. Once inside the maximum allowed angular error 260, the shot is executed. It should be noted that boresight shift between the gimbals is preferably calculated in real-time, using ballistic calculations, wind vector calculations or both.

Reference is also made to FIG. 4, illustrating a top perspective view of an example hovering firearm system 300, according to aspects of the present disclosure, the firearm system including two interdependent gimbals. Hovering firearm system 300 is similar to firearm system 200, but instead of using two independent gimbals 130 and 234, the EO gyro-stabilized gimbal 234 is attached onto firearm gimbal 130, forming a single, interdependent apparatus.

Being attached to same base point, the angular error formed is lower than in the firearm system 200 configuration, due to the non-linearity of encoders involved. Thus, in apparatus 300 (“EO gimbal 234 on firearm gimbal 130”) the boresight position is always reached by firearm gimbal 130, as the angular position of EO gimbal 234 is centripetal and thereby proximal to the EO center point.

It is a further aspect of the present disclosure to provide a firearm having a recoil-prevention mechanism, while using off-the-shelf ammunition.

According to some aspects of the present invention, there are provided firearm recoil-prevention mechanisms utilizing active recoil cancellation. The active recoil cancellation uses an additional cartridge/combustion powder that generates a thrust force that is predesigned to cancel the recoil of the primary cartridge by providing a counter symmetric thrust in a direction that is exactly opposite to the direction of recoil generated by the detonated primary cartridge.

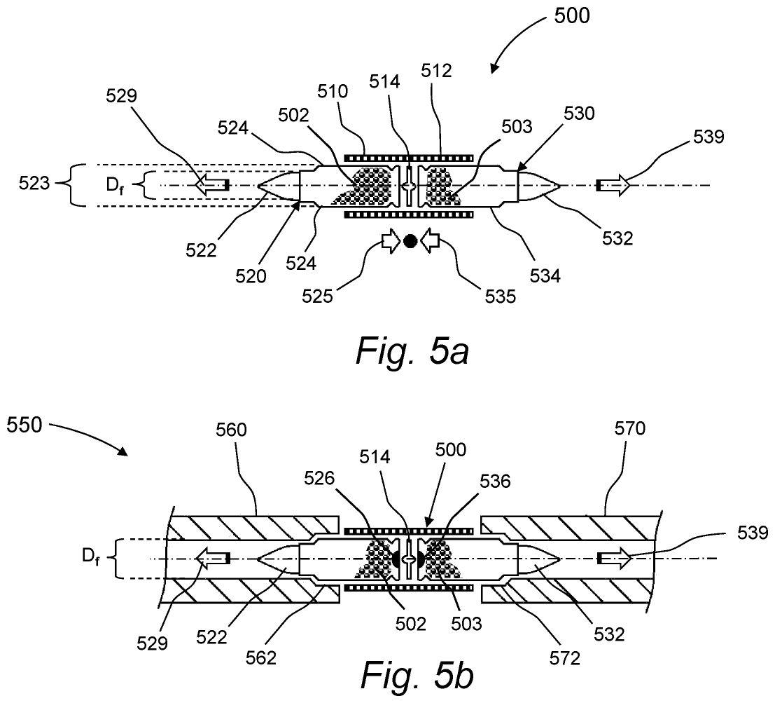

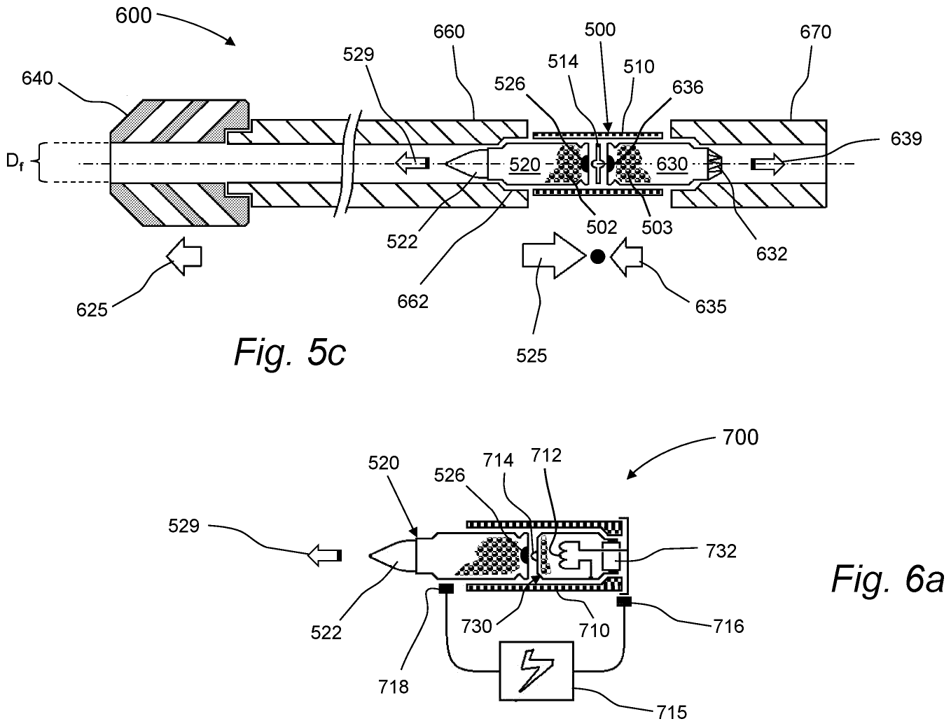

Reference is now made to FIG. 5a, showing a top, partial cross-section view of an active recoil cancelation mechanism 500, according to aspects of the present disclosure. The active recoil cancelation mechanism 500 apparatus takes the form of a dual-cartridge assembly. The active recoil cancelation mechanism 500 includes a dual-cartridge assembly 510, configured to accommodate one or more pairs of a primary cartridge 520 and a secondary cartridge 530, and a dual firing pin unit 514 having dual firing pins.

Each pair of cartridges includes a primary cartridge 520 and secondary cartridge 530 that are arranged back-to-back inside the dual-cartridge assembly 510, wherein each cartridge (520, 530) can be a common cartridge, having a bullet (522, 532) and a bullet casing (524, 534). The primary cartridge 520 is a “combat” cartridge, while the secondary cartridge 530 can be any kind of a “dummy” cartridge.

In the example shown in FIGS. 5a and 5b, the dual-cartridge assembly 510 is a symmetric dual-cartridge assembly 510. Upon applying a hammering force onto both cartridges (520 and 530) a chain reaction of both cartridges (520 and 530) begins. The dual firing pin unit 514 splits the hammer force between respective primers (526, 536) of the cartridge cases (524, 534), to thereby generate simultaneous ignition of both cartridges (520 and 530), to thereby detonate the respective gunpowder (502, 503) stored there inside, and generated respective thrusts (525, 535), whereby equal recoil forces are formed by the generated thrusts (525, 535). The recoil force formed by the generated thrust 535 is equal to the recoil force formed by the generated thrust 525, whereas by being in opposite directions, the two recoil forces cancel each other.

It should be noted that in order to simplify the operation of the firearm, dual-cartridge assembly 510 is configured as a single unit that is loaded into firearm corresponding feeding mechanism (not shown).

It should be noted that the embodiment principle of active recoil cancelation apparatus 500, may be implemented is various variations as shown in the following examples, all of which are within the scope of the present invention.

FIG. 5b illustrates a top, partial cross-section view of one example embodiment of a firearm 550 of the dual-cartridge assembly 500 shown in FIG. 5a. Firearm 550 includes a front (“combat”) barrel 560 and a rear (“dummy”) barrel 570, wherein front barrel 560 and a rear barrel 570 are equal in length. Both primary cartridge 520 and secondary cartridge 530 are of the same type, including the same weight and quantity of gunpowder (502, 503). In this example the front combat barrel 560 is fixed while the rear barrel 570 is utilized as a hammer is used to transfer the detonation impact energy, as described hereabove.

Upon simultaneously activating dual firing pin unit 514 on both primers 526 and 536, respectively, the recoil force formed by the generated thrusts 535 and 525, whereas by being in exact opposite directions, the two recoil forces cancel each other, while the front bullet 522 ejects from front barrel 560 in a forward direction and the rear bullet 532 ejects from rear barrel 570 in a backward direction.

It should be further noted that when using common cartridges (520, 530), there are often variations in the gunpowder (502, 503) quantity, the respective primers (526, 536), etc. Furthermore, the dual barrels firearm 550 has about double the size and double the weight of a compatible single barrel firearm. To overcome the above-mentioned deficiencies of firearm 550, the following improved embodiments are described.

It should be further noted that the bullet (522, 532) in each common cartridge (520, 530) has a rear section and a front section, wherein the rear section of the bullet seals the front end of the casing (524, 534). The barrel of the firearm has an inner-barrel-diameter D_{f}, the rear section of a bullet (522, 532) has an external diameter that is fitted to the inner-barrel-diameter D_{f} of the respective firearm barrel (that is, the rear section of a bullet (522, 532) has an external diameter that is slightly larger than the inner-barrel-diameter D_{f} of the respective firearm barrel to thereby obtain a sealing effect, to maximize the respective thrust force, whereas the bullet is made of a much softer material than the material of the respective barrel). Furthermore, the casing (524, 534) of the respective cartridge has an external diameter that is larger than the inner-barrel-diameter D_{f}.

FIG. 5c illustrates a top, partial cross-section view of one example embodiment of a firearm 600 of the dual-cartridge assembly 500 shown in FIG. 5a, wherein the dual-cartridge assembly 500 is utilized as a first asymmetric dual-cartridge assembly. As in firearm 550, firearm 600 includes a front (“combat”) barrel 560 and a rear (“dummy”) barrel 570, however, front barrel 660 and a rear barrel 670 are not equal in length. Front barrel 660 has a normal length adapted to shoot front bullet 522 forward therethrough at a preconfigured ballistic path. Rear barrel 670 is shorter than the length of front bullet 522. The primary cartridge 520 is a “combat” cartridge, while the secondary cartridge 630 may be a “combat” cartridge of the same type or just dummy or blank cartridge. As such, firearm 600 is preconfigured to the have primary cartridge 520 generate a recoil force 525 (Fₚ) that is higher than the recoil force 635 (Fₛ) generated by secondary cartridge 630, such that: Fₛ+ΔF=Fₚ.

The difference in thrust forces ΔF between the primary and secondary cartridges (520 and 630) is compensated using an additional recoil compensation element—a muzzle-brake 640. Generally, a recoil compensator (such as, with no limitations, a muzzle brake) is a device known in the art that is connected to the muzzle of a firearm and redirects propellant gasses to counter recoil and unwanted muzzle rise. In firearm 600, muzzle-brake 640 is configured to compensate for the difference in thrust forces ΔF, by redirecting some of the primary cartridge propellant gasses. Muzzle-brake 640, in conjunction with the recoil force 635 generated by secondary cartridge 630, combine into a force that is equal to the recoil force 525 (Fₚ) generated by primary cartridge 520 in direction opposite to primary cartridge recoil Fₚ.

The advantage of firearm 600 over firearm 550, is having lower firearm length and lower firearm weight, and can use a secondary ammunition unit that is has a lighter weight than the weight of the primary cartridge 520, such as, with no limitations, a dummy secondary cartridge 630. It should be appreciated that the disbalance between the primary and secondary cartridges (520 and 630, respectively) gunpowder (502, 503) charges has less effect, since the recoil force 525 of the primary cartridge 520 and the “muzzle brake” thrust force 625 are both generated by the primary cartridge gunpowder 502. Thus, the muzzle-brake 640 is designed proportionally, in order to keep the following balance: Fₛ+ΔF=Fₚ. For example, if the 640 is designed to reduce the required rear recoil force 635 (Fₛ) by half, that is ΔF=0.5Fₚ, the required rear recoil force 635 (Fₛ) is also Fₛ=0.5Fₚ, a disbalance between the primary and secondary cartridges (520 and 630, respectively) gunpowder (502, 503) charges has only half the effect compared to when Fₛ=Fₚ. It should be appreciated that another recoil reduction element, such as a jet nozzle may be placed at end of the rear barrel 670, wherein the rear jet nozzle generates forward thrust from exhaust propellant gasses.

It should be appreciated that a recoil compensator such as a muzzle-brake or a jet nozzle may be placed on either the front barrel or the rear barrel, as needed, to compensate for an expected difference in recoil thrust forces ΔF.

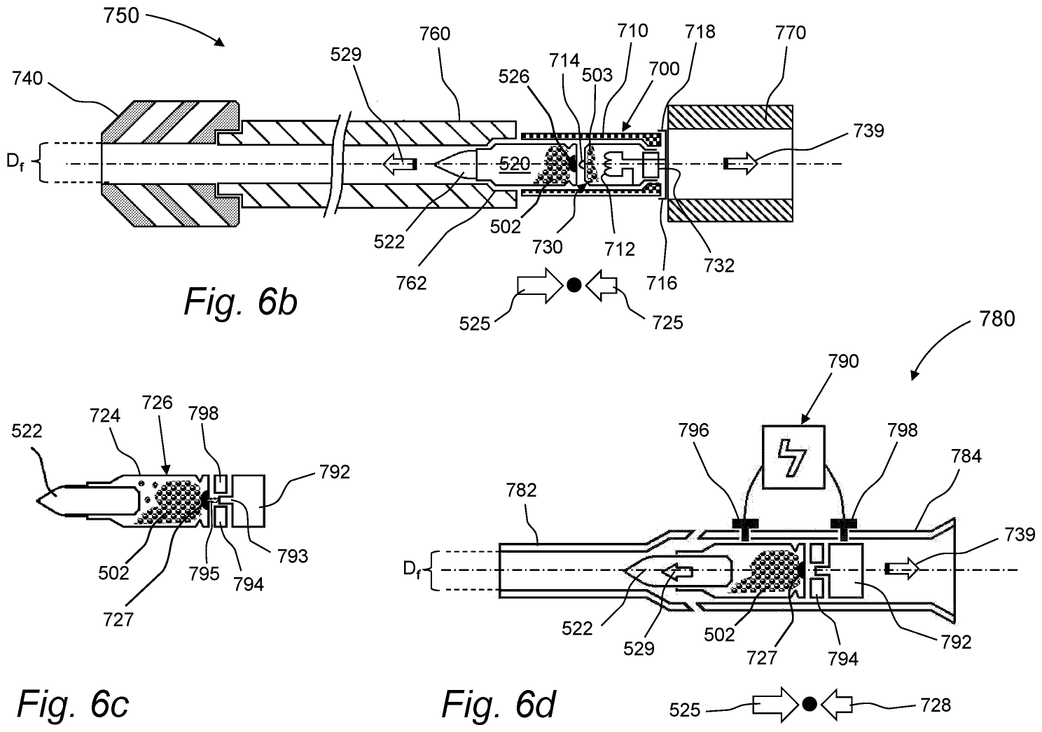

According to further variations of the present disclosure, FIG. 6a illustrates a top, partial cross-section view of a dual-cartridge assembly 700, according to aspects of the present disclosure, wherein the dual-cartridge assembly 700 is utilized as a second asymmetric dual-cartridge assembly, and wherein a disposable secondary cartridge 730 contains an electric ignition circuit.

Dual-cartridge assembly 700 uses the same principles of active recoil cancelation 500 apparatus, wherein each pair of cartridges includes a primary cartridge 520 and secondary cartridge 730 that are arranged back-to-back inside a dual-cartridge firearm magazine assembly 710 being a recoilless cartridge assembly and wherein primary cartridge 520 is preferably a common, off-the-shelf cartridge.

Reference is also made to FIG. 6b that illustrates a top, partial cross-section view of one example embodiment of a firearm 750 of the dual-cartridge assembly 700. The secondary cartridge 730 is an innovative cartridge having an electric, dual-ignition circuit built-in. Secondary cartridge 730 further includes an electronic ignition heater 712 and a firing pin unit 714 that is an integral part of secondary casing 730. Secondary cartridge 730 further includes a sealing unit 732 that can also serve as a counterweight to the weight of primary cartridge 520, in addition to propellant gasses that find their way out.

Upon receiving an electronic ignition trigger a high voltage module 715 turned on the electronic ignition heater 712 to thereby detonate the gunpowder 503 disposed inside secondary casing 730. As a result of that detonation, secondary casing 730 is shifted forward and firing pin unit 714 detonates the primer 526 of primary cartridge 520. The rest of the chain reaction is similar to that described with respect to firearm 550, wherein secondary casing 730 is ejected in direction 739 out of a rear barrel 770. The electronic ignition voltage is transferred, for example, with no limitations, to primary cartridge 520 via two (or more) electrodes (716 and 718) and primary cartridge 520, wherein cartridge assembly 710 is made from a dielectric material.

The main advantage of dual-cartridge assembly 700 is that a mechanical hammer firing mechanism is not required, therefore simplifying the feeding mechanism and the synchronization of the ignition process.

Another advantage of the electronic ignition is that the order in which the cartridges are ignited is known, whereas when the order in which the cartridges are ignited is unknown, the firearm has an unpredictable barrel motion during the fire process (since the physical properties ammunition units are not perfectly repeatable), which may cause growing divergence of the bullets and increase the spread.

It should be appreciated that firearm 750 is preconfigured to the have primary cartridge 520 generate a recoil force 525 (Fₚ) that is higher than the recoil force 725 (Fₛ₂) generated by secondary cartridge 730, such that: ΔF=Fₚ, −Fₛ₂. Hence, similar to muzzle-brake 640, the difference in thrust forces ΔF between the primary and secondary cartridges (520 and 730) is compensated using an additional recoil compensation element—a muzzle-brake 740.

In variations of the present invention, an electrical ignition mechanism is used. An example prior art electrical ignition mechanism is a rifle manufactured by Remington: Model 700 EtronX, which uses an electronic primer ignition system.

Reference is also made to FIG. 6c including a cartridge 726 having a bullet 522 and a bullet casing 724 containing a primer 727. FIG. 6c further illustrates a counter-weight 792 having an electric arc generation unit 793.

FIG. 6d schematically illustrates an example firearm 780 that utilizes cartridge and counter-weight sub-system shown in FIG. 6c. Firearm 780 includes a front barrel 782 and a rear barrel 784. Firearm 780 further includes an electrical ignition mechanism 790 configured to generate a high ignition voltage that is applied via two electrodes (796 and 798), for example to bullet casing 724 and to counter-weight 792, wherein both said bullet casing 724 and said counter-weight 792 are made from conductive materials and separated by an insulator (for example insulator 794). By way of example, insulator 794 has an opening formed at the middle, facing primer 727. Thus, when electricity is applied to electrodes 796 and 798, an electric arc 795 is formed between said counter-weight 792 and said primer 727. To better centralize the electric arc a conductive protrusion extends from said counter-weight 792 and towards said primer 727. The electric arc 795 heats primer 727, to thereby detonate gunpowder 502 inside bullet casing 724. As a result of that detonation, casing 730 is shifted forward and firing pin unit 714 detonates the primer 526 of primary cartridge 520. The rest of the chain reaction is similar to that described with respect to firearm 550, wherein bullet casing 724, insulator 794 and counter-weight 792 are ejected in direction 739 out of a rear barrel 784.

It should be appreciated that at least one or both electrodes (796 and 798) are electrically insulated from the gun barrels (782 and 784). According to some aspects of the present invention, there are provided recoil-prevention mechanisms using an off-the-shelf cartridge with a single gunpowder charge, wherein the generated gunpowder energy is split between the bullet that is fired through the firearm front barrel, and the bullet/casing that used as counter mass that is fired through the rear of the firearm, without applying a recoil force to the firearm itself. The recoil-prevention mechanisms of the present disclosure provide solutions for elimination of recoil energy transfer caused by primer ignition, facilitating usage of standard cartridge while proving recoilless operation including solution for primer ignition and feeding mechanisms.

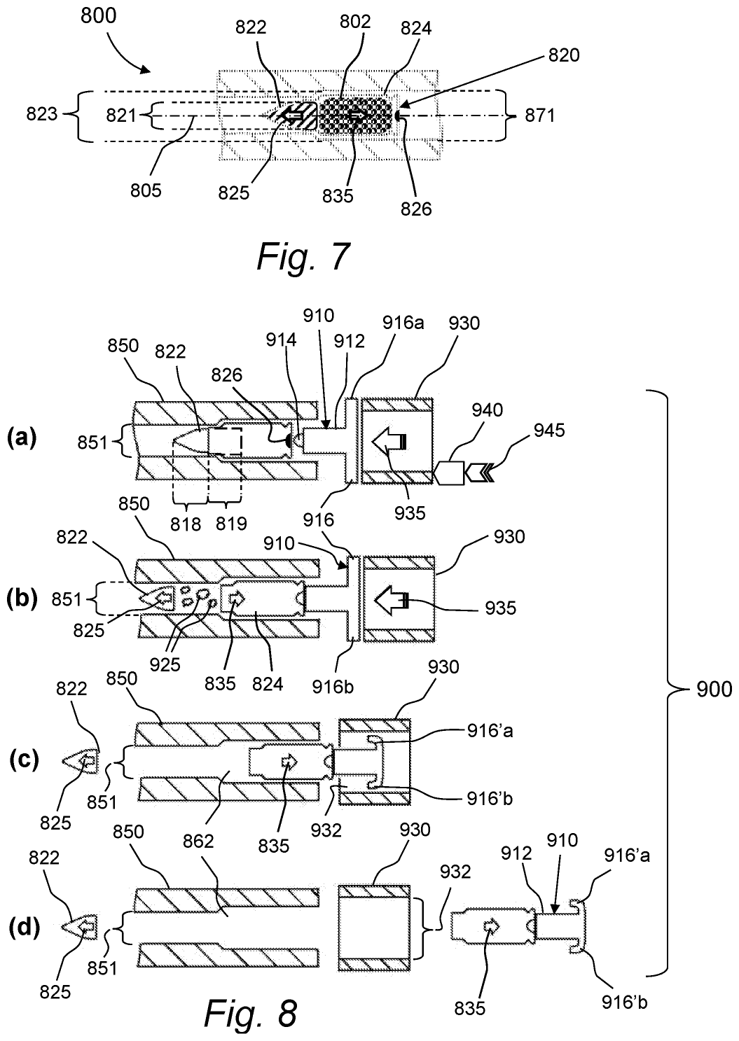

Reference is now made to FIG. 7 and FIG. 8(a), illustrating a partial cross-section view of a portion of a recoilless firearm 800, showing the principles of a counter-mass mechanism, according to aspects of the present disclosure. The counter-mass mechanism of recoilless firearm 800 utilizes a single, standard (off-the-shelf) cartridge 820 that includes a bullet 822 having a rear section 819 and a front section 818, bullet casing 824 wherein rear section 819 of bullet 822 seals the front end of casing 824, gunpowder 802 and primer 826. However, this common sealing method is given by way of example only, with no limitations on other mechanisms and/or methods, known in the art, for sealing a standard cartridge. It should be appreciated that these sealing methods can be used herein within the scope of the present disclosure.

The barrel of recoilless firearm 800 has an inner-barrel-diameter D_{f}, wherein the rear section 819 of a bullet 822 has an external diameter 821 that is fitted to the inner-barrel-diameter D_{f} of the respective firearm barrel. Furthermore, the casing 824 of the respective cartridge has an external diameter 823 that is larger than the inner-barrel-diameter D_{f} of the respective firearm barrel.

It should be further noted that a cartridge assembly 820 is placed before firing in a fitted cartridge-chamber 862 that is wider than D_{f}, to thereby allow to accommodate cartridge assembly 820, but upon firing, the bullet ejects out of inner-barrel-diameter D_{f}, wherein casing 824 absorbs the recoil force and is thus pushed backward by the formed gases.

It should be appreciated that although the description refers to firearm cartridges that includes a bullet and a casing, the same principles can be applied to other known-in-the-art ammunition types, for example: shotgun shell with any payload selected from the group including projectile, slug, shot and pellets.

It should be further noted that standard ammunition, such as cartridge assembly 820, is not designed for recoilless operation. Conventionally, cartridge assembly 820 is configured to be detonated, when a mechanical hammer (not shown) hits the centerfire mechanical primer 826 of cartridge assembly 820, to thereby detonate gunpowder 802 disposed inside bullet casing 824. When primer 826 ignites, it is almost impossible to prevent the transfer a large portion of the formed recoil energy from the bullet casing 824 back to the hitting hammer of the firearm.

By using a counter-mass mechanism, according to aspects of the present disclosure, such a recoil effect can be prevented. The barrel of recoilless firearm 800 has a barrel front opening 851 (D_{f}) and, according to aspects of the present disclosure, a barrel rear opening 871. When bullet 822 is fired in the direction (825) of target, through the firearm front opening 851 (D_{f}) of recoilless firearm 800, in the direction of target, bullet casing 824 is used as a counterweight to the fired bullet 822, wherein bullet casing 824 is fired in an opposite direction through the rear opening 871 of recoilless firearm 800, whereas energy generated by the detonated gunpowder 802 is split between bullet 822 and bullet casing 824, firing them in opposite direction, without any recoil force effecting the recoilless firearm 800.

FIGS. 8a-8d illustrate a firearm assembly and methodology 900 of using thereof, in a partial cross-section views, an example structure and the firing steps of using an example piped bolt-hammering-unit 930 and a disposable firing pin 910, to bring about detonation and the shooting chain of events involved. Firearm assembly and methodology 900 solves the problem formed by the recoil force transfer through hammer using the principles outlined in FIG. 7. When activated, a unidirectional energy transfer mechanism 940 transfers a forward thrust 945 to bolt-hammering-unit 930 that thereby moves forward in direction 935.

Thus, in first firing step, piped bolt-hammering-unit 930 moves forward in direction 935, meets firing pin 910 and continuous to move forward until the firing pin 910 pecks primer 826, as shown in the example illustrated in FIG. 8(b), to thereby ignite primer 826 and thereby detonate gunpowder 802 disposed inside cartridge casing 824 to initiate the firing of bullet 822 in a forward direction 825.

While the explosion of gunpowder 802 generates propellant gasses 925 that, on the one hand push bullet 822 in a forward direction 825, the propellant gasses 925 also push bullet casing 824 in the opposite direction 835. However, unidirectional energy transfer mechanism 940 prevents bolt-hammering-unit 930 from moving back in direction 935. As a result, as shown in the example illustrated in FIG. 8(c), bullet casing 824 is pushed back by propellant gasses 925, wherein recoil force are applied to firing pin 910 and bolt-hammering-unit 930. While bolt-hammering-unit 930 is blocked by unidirectional energy transfer mechanism 940, the recoil force is applied to firing pin 910 and cause the deformation or the breaking a part of the firing pin 910, as will be further described here below. The deformed firing pin 910 and any parts thereof then slides through the inner opening 932 of bolt-hammering-unit 930.

In the last firing step, as shown in the example illustrated in FIG. 8(d), both firing pin 910 and bullet casing 824, that absorb the energy of the recoil are flown out through inner opening 932 of bolt-hammering-unit 930 out of the firearm rear.

In the example shown in FIGS. 8a-8d, a non-limiting example of a disposable firing pin 910 is shown, and an example methodology 900 of using thereof. Firing pin 910 include a pin 914, a pin-body 912 and wings 916. In the example shown in FIGS. 8c-8d, the deformation takes a non-limiting form of the bending of wings 916 of disposable firing pin 910. As such, pin-body 912 is predesigned to withstand the recoil force and wings 916 are predesigned to band at a preconfigured location and force.

It should be noted that a predesigned muzzle-brake 640 can be added to the recoilless firearm, wherein a muzzle-brake 640 is used to cancel the small residual portion of the recoil energy formed during deformation of disposable firing pin 910.

It should be appreciated that recoilless operation of a firearm that uses standard ammunition can be achieved by preventing the recoil energy, formed upon detonation of the primer 826, from being transferred back to firearm hammer. According to aspects of the present this is achieved by using a disposable firing pin that is deformed or broken apart by the bursting recoil energy and eject from the firearm, along with the ammunition casing, via a designated escape path, which bypasses the hammer.

It should be noted that the disposable firing pin may have a variety of shapes and can be operatively coupled to the hammer and/or to the ammunition by any form or method.

As mentioned hereabove, a unidirectional energy transfer mechanism of a bolt-hammering-unit 930 may be embodied in numerous ways and shapes, whereas the piped shape is presented as an example only, with no limitation. The objective of a hammer unidirectional energy transfer mechanism is to allow bolt-hammering-unit 930 the to move freely and linearly in a first direction (825), and be blocked when trying to move in the opposite direction (835). Thereby, allowing free motion towards primer 826 and block the return upon the formation of the propellant gasses 925.

According to aspects of the present disclosure, there are provided example embodiments of a hammer unidirectional energy transfer mechanism 940, wherein the unidirectional energy transfer mechanism is securely coupled with the bolt-hammering-unit 930. In some embodiments, a ratchet-based or motion limitation mechanisms are used, wherein a motion limitation mechanism is locked after the ammunition, such as cartridge assembly 820, is fitted into inner opening 932 of bolt-hammering-unit 930 and limits the bolt-hammer-unit 930 backward motion, and wherein a ratchet-based mechanism allows only unidirectional linear motion while preventing motion of the moving part in the opposite direction. It should be noted that any motion limitation mechanism, known in art as a “breechblock locking mechanism”, for example, a breech locking mechanism shown in https://en.wikipedia.org/wiki/Rotating_bolt, can be used as a unidirectional linear motion to block rearward motion of the bolt-hammer-unit 930, while in a cocked state.

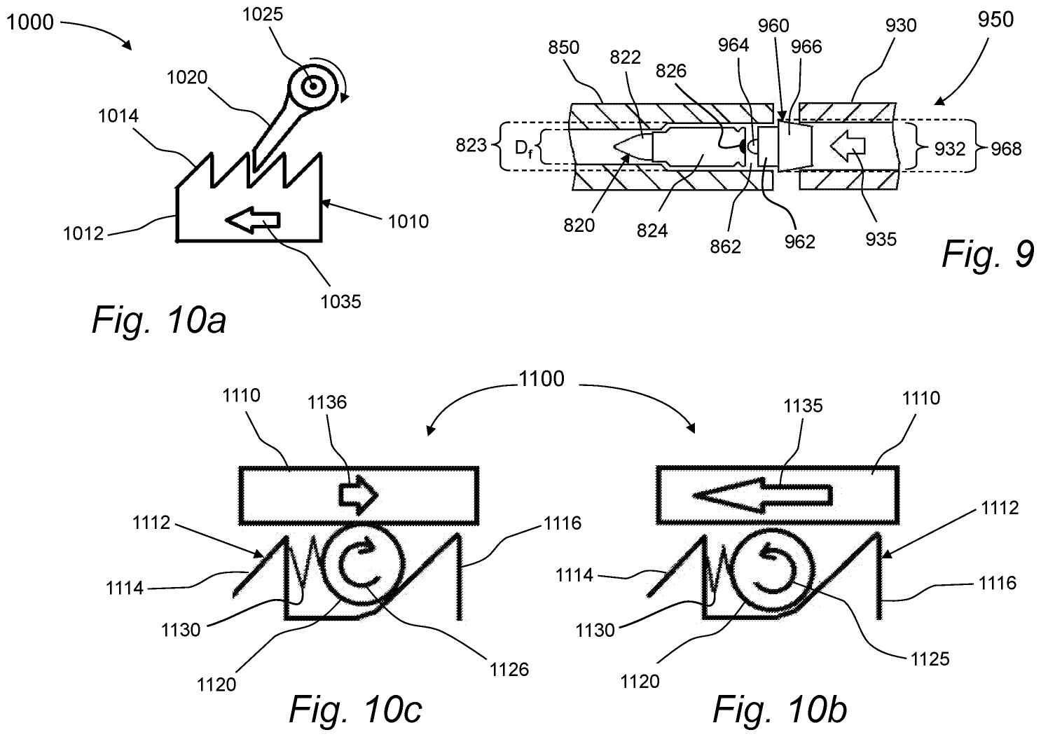

Reference is now made to FIG. 9, illustrating a partial cross-section view of a portion of a recoilless firearm 950, showing the principles of a counter-mass mechanism, according to other aspects of the present disclosure. The counter-mass mechanism of recoilless firearm 950 utilizes a single, standard (off-the-shelf) cartridge 820 that includes a bullet 822, a bullet casing 824 wherein the rear section of bullet seals the front end of casing 824, gunpowder and a primer 826. However, this common sealing method is given by way of example only, with no limitations on other mechanisms and/or methods, known in the art, for sealing a standard cartridge. It should be appreciated that these sealing methods can be used herein within the scope of the present disclosure.

The front barrel 850 of recoilless firearm 950 has an inner-barrel-diameter D_{f}, wherein the casing 824 of the respective cartridge has an external diameter 823 that is larger than the inner-barrel-diameter D_{f} of the respective firearm barrel.

It should be further noted that a cartridge assembly 820 is placed before firing in a fitted cartridge-chamber that is wider than D_{f}, to thereby allow to accommodate cartridge assembly 820, but upon firing, the bullet ejects out of inner-barrel-diameter D_{f}, wherein casing 824 absorbs the recoil force and is thus pushed backward by the formed gases.

It should be appreciated that although the description refers to firearm cartridges that includes a bullet and a casing, the same principles can be applied to other known-in-the-art ammunition types, for example: shotgun shell with any payload selected from the group including projectile, slug, shot and pellets.

As shown in FIG. 9, recoilless firearm apparatus 950 utilizes another counter-mass mechanism 960, according to aspects of the present disclosure, such that a recoil effect can be prevented. Counter-mass mechanism 960, being another embodiment of a disposable firing-pin, includes a frontal-body-section 962 having a pin-front-end, being an open end, wherein a pin 964 is disposed at the pin-front-end. Counter-mass mechanism 960 further includes a rear-body-section 966 having a pin-rear-end with a larger diameter end 968, wherein the larger diameter of said pin-rear-end is configured to seal the rear discharge opening (similar to the rear opening 871 of recoilless firearm 800) of front barrel 850.

When in a cocked state, the rear of the standard cartridge is seated inside the cartridge-chamber 862 and the pin 964 is positioned in safe proximity to the primer 826, as shown in FIG. 9. Typically, the firing pin is made of rigid materials, while at least the rear-body-section 966, including the larger diameter end, is made of deformable or breakable materials, such that when applying an excess force Fₑ onto firing pin 964, the Counter-mass mechanism 960 deforms or breaks.

In one embodiment, a first ratchet-based mechanism is used. FIG. 10a illustrates a unidirectional energy transfer mechanism 1000, according to aspects of the present disclosure. Unidirectional energy transfer mechanism 1000 includes a linear moving part 1010 having one or more saw teeth 1014 and a pivotal leaping-arm 1020 configured to pivot about axis 1025. As linear moving part 1010 moves, in the example shown, in direction 1035, leaping-arm 1020 pivotally leaps over the sloped side of the next tooth 1014, wherein when linear moving part 1010 tries to move in an opposite direction to direction 1035, leaping-arm 1020 gets stuck in the generally vertical side of the next tooth 1014.

In another embodiment, a second ratchet-based mechanism is used. FIGS. 10b and 10c illustrate another example unidirectional energy transfer mechanism 1100, according to some other embodiments of the present disclosure. Unidirectional energy transfer mechanism 1100 includes a linear moving slider 1110, being the moving part, a motion control element 1112 having one or more saw teeth 1112 and a moving ball 1120, disposed between the generally vertical side 1116 of a first tooth 1112 and the sloped side 1114 of a second tooth 1112, wherein moving ball 1120 is securely interconnected to the vertical side 1116 of the first tooth 1112 by a biasing element such as, with no limitation, a spring 1130. As linear moving slider 1110 moves in direction 1135, as shown in the example illustrated in FIG. 10b, biasing element 1130 maintains moving rotating (in direction 1125) ball 1120 free such that linear moving slider 1110 can move freely. When linear moving slider 1110 tries to move in an opposite direction (1136, as shown in the example illustrated in FIG. 10c) to direction 1135, biasing element 1130 pushes moving rotating (in direction 1126) ball 1120 and thereby moving ball 1120 climbs over the sloped side 1114 of a second tooth 1112 such that moving ball 1120 gets stuck between the sloped side 1114 of a second tooth 1112 and the bottom of linear moving slider 1110, to thereby block linear moving slider 1110 from moving further in direction 1136.

It should be noted that there are many motion-limiting and ratchet mechanisms, principles and modifications known in art that used in industrial and automotive applications, including a “seat belt”, wherein when a “seat belt ratchet” is pulled in slow motion, it moves freely, it holds the passenger in place comfortably, and when the “seat belt ratchet” is pulled in fast motion, the seat belt is held in place keeping the passenger in place. In some of the prior art ratchet mechanisms the saw teeth are replaced by bearings or rollers to provide fast response and bearing of high pressure. Hence, the present disclosure is not limited in using any specific ratchet mechanism known in art.

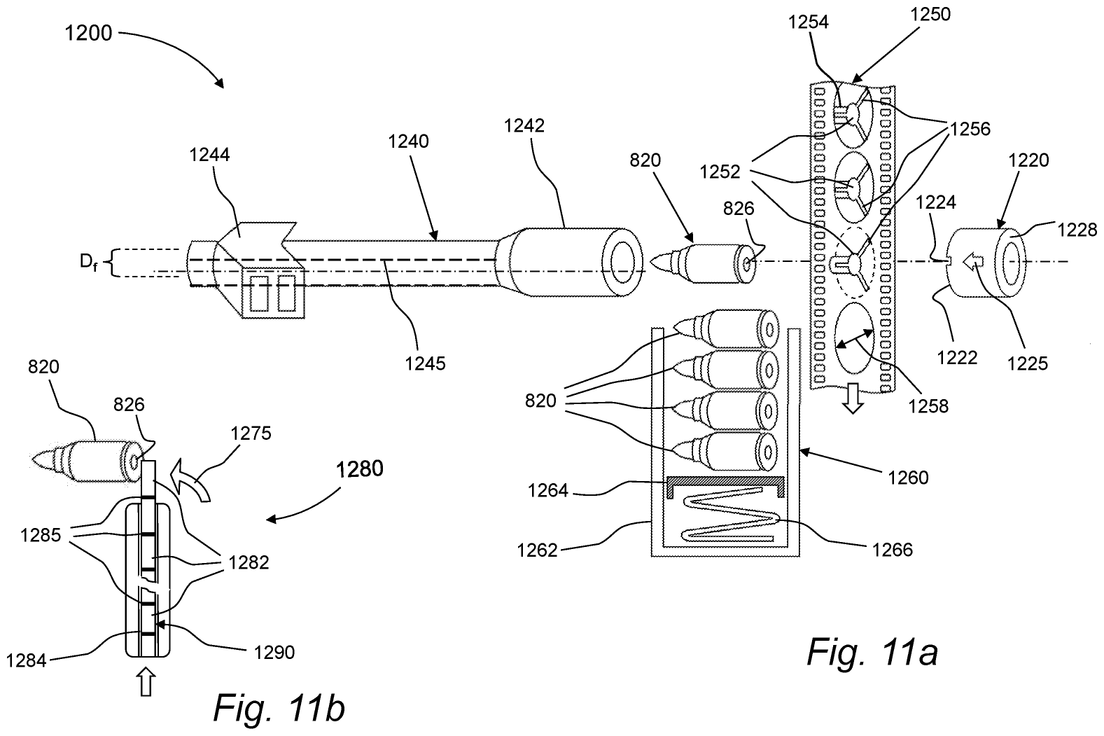

According to aspects of the present disclosure, there is provided an example firearm system 1200, as illustrated in FIG. 11a, that utilizes the methodology of firearm assembly and methodology 900. Firearm system 1200 includes a barrel 1240 having a cartridge-chamber 1242, at least one disposable firing pin 1252 and a piped bolt-hammering-unit 1220 (similar to piped bolt-hammering-unit 930). In this non-limiting example, each firing pin 1252 includes at least two wings 1256 (similar to wings 916), a pin (not shown) similar to pin 914 and a pin-body 1254 (similar to pin-body 912). In the frontal face of piped bolt-hammering-unit 1220, grooves 1224 are formed, each configured to accommodate a respective wing 1256 of firing pin 1252.

Optionally, firearm system 1200 further includes a cartridge magazine 1260, adapted to hold cartridges 820, for automatic and semi-automatic firearms. In such embodiments, and other embodiments, respective multiple disposable firing pins 1252 may be supplied via a separate, continuous band magazine 1250 having multiple disposable firing pins 1252.

When firearm system 1200 is activated, a unidirectional energy transfer mechanism transfers a forward thrust to piped bolt-hammering-unit 1220 that thereby moves forward in direction 1225, according to the methodology described with respect to firearm assembly and methodology 900. A respective firing pin 1252 is dispatched from band magazine 1250, wherein wing 1256 of firing pin 1252 are sat inside respective grooves 1224 of piped bolt-hammering-unit 1220, while piped bolt-hammering-unit 1220 moves forward through band magazine 1250, until the pin of disposable firing pin 1252 pecks primer 826 of cartridge assembly 820, and the firing sequence begins, including the bending of wings 1256 of firing pin 1252 and including both firing pin 1252 and bullet casing 824, that absorb the energy of the recoil are flown out through the inner opening of piped bolt-hammering-unit 1220, out of the rear of firearm system 1200.

Other example embodiments of hammer unidirectional energy transfer mechanisms will now be described. According to aspects of the present disclosure, there are provided example embodiments of a unidirectional energy transfer mechanism 940, wherein a bolt-and-hammer mechanism are used.

It should be noted that the disposable firing pin may come in the form of being detachably embedded in an elongated band magazine, wherein a single firing pin is torn off from the band in each shot. An example of such embodiment is detailed with respect to band magazine 1250, described hereabove. According to aspects of the present invention, the disposable firing pin may also come in the form of being detachably mounted on an elongated stick of firing pin, wherein a single firing pin is torn off from the stick in each shot. The stick may be straight, arched or in a circled form. Another non-limiting example illustrates in FIG. 11b a stick magazine 1280. Stick magazine 1280 includes rigid segments of firing pin 1282, that are interconnected by a breakable element 1285. When a hitting force 1275 is applied to the firing pin 1282 that is first in line, the end of the stick serves as the pecker that pecks the primer 826. The wire stick then moves up whereas the next in line firing pin segment 1282 becomes the first in line firing pin segment 1282.

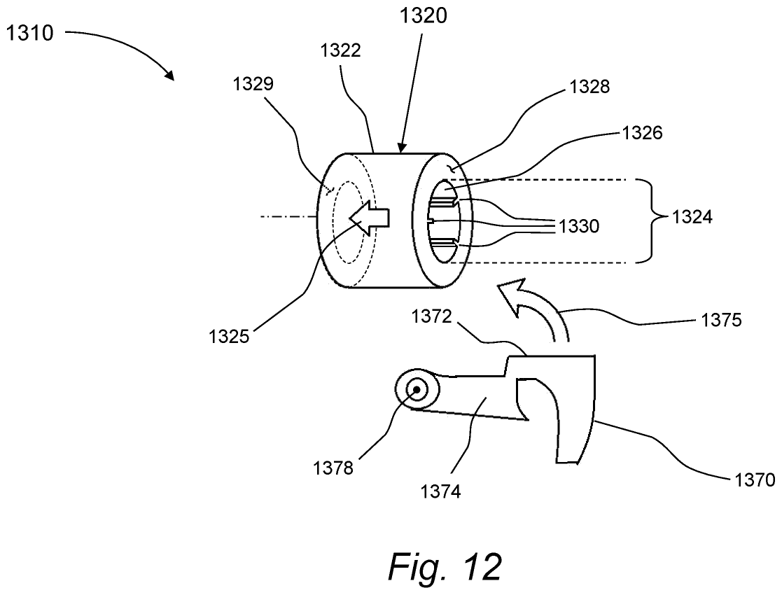

FIG. 12 illustrates a unidirectional energy transfer mechanism 1310, according to aspects of the present disclosure. Unidirectional energy transfer mechanism 1310 includes a ribbed bolt-hammering-unit 1320 and a hammer 1370. Piped bolt-hammering-unit 1320, being the bolt, has an opening 1324 formed there at the center, and one or more directing ribs 1330 placed at preconfigured locations of the inner wall 1326 of opening 1324.

Hammer 1370 includes a pivotal arm 1374 configured to pivot about axis 1378, and a hitting face 1372. When hammer 1370 is activated, it pivots forcefully in direction 1375, wherein upon hitting face 1372 impacting a proximal end face 1328 of ribbed bolt-hammering-unit 1320, ribbed bolt-hammering-unit 1320 moves linearly forward with respect to the respective firearm, in direction 1325.

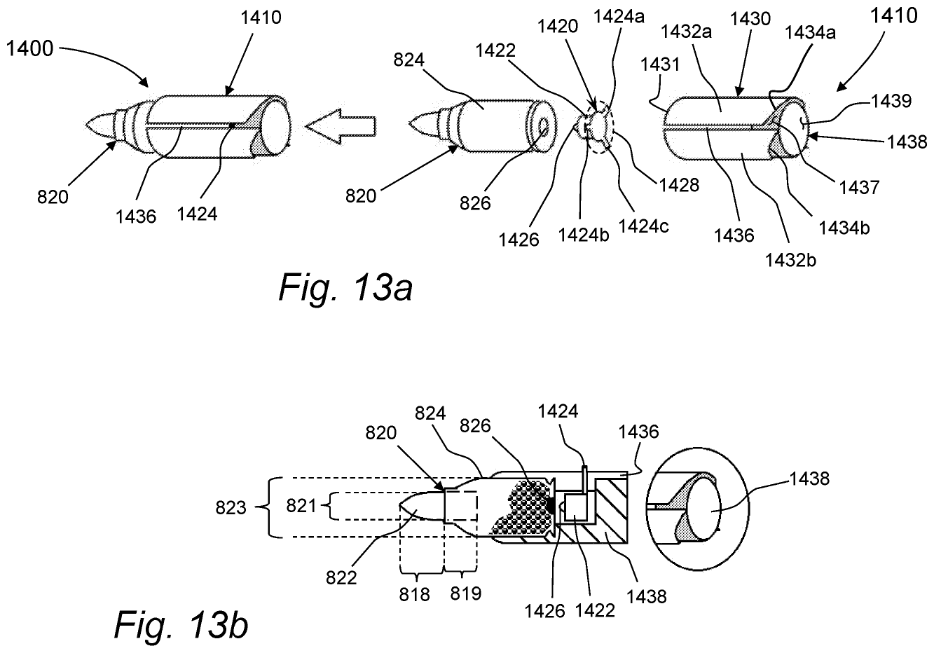

According to aspects of the present disclosure, there is provided an example recoilless-cartridge-assembly 1400, as illustrated in FIG. 13a in an exploded view. FIG. 13b is a cross-section view of recoilless-cartridge-assembly 1400. Recoilless-cartridge-assembly 1400 includes a standard cartridge, such as cartridge 520/820, and a detonation assembly add-on 1410, adapted to fit onto standard cartridge 820.

Detonation assembly 1410 includes a cylindrical-envelope 1430 having an inner diameter, an external diameter, a front end 1431 and a rear end 1434, wherein the front end 1431 operatively faces the barrel of the hosting firearm. The cylindrical-envelope 1430 is enclosed at the rear end side by a cylindrical rear plug, having a cup shape. Cylindrical cup rear plug 1438 includes an enclosed cylindrical wall 1437 enclosed at the rear end by plug-wall 1439, wherein cylindrical-envelope 1430 is securely attached onto the external surface of cylindrical wall 1437. It should be noted that detonation assembly 1410 can be made of a single unit.

Detonation assembly 1410 further includes a disposable firing pin 1420 that is similar to disposable firing pin 910. Disposable firing pin 1420 includes a pin 1426, a pin-body 1422 and at least one wing 1424, having a wing-span diameter 1428.

When operatively assembled, firing pin 1420 is inserted into cylindrical-envelope 1430 via front end 1431, wherein pin 1426 faces the barrel of the hosting firearm. However, the peripheral wing-span diameter of the ends of the at least one wing 1424 is purposely larger than the internal diameter of cylindrical-envelope 1430 and is smaller than external diameter of cylindrical-envelope 1430. In order to insert firing pin 1420 into cylindrical-envelope 1430, a fitted through slit 1436 is formed, for each respective wing 1424, in cylindrical-envelope 1430, extending from front end 1431 to rear end 1434.

Hence, when operatively assembled (or manufactured), each slit 1436 accommodates a respective wing 1424, such that the open end of each wing 1424 sticking out of the slit 1436, as illustrated in FIG. 13b. The inner diameter of rear end 1434 of cylindrical-envelope 1430 is enclosed by a rear plug 1438, to which inner surface of cylindrical-envelope 1430 rear plug 1438 is securely attached.

It should be noted that slits 1436 segment cylindrical-envelope 1430 into separate peripheral segments 1432, wherein the number of slits 1436, the number of wings 1424, and the number of peripheral segments 1432 is equal. However, the of slits 1436 may be twice the number of wings 1424. It should be further noted that the rear end 1434 of each peripheral segment 1432 is sloped, starting at a first corner of the rear end 1434 of the peripheral segment 1432 (and proximal to the rear end of rear plug 1438), ending at the other corner of the rear end 1434 of that peripheral segment 1432, formed by the next slit, and at a predesigned distance from the rear end of rear plug 1438.

It should be further noted that when recoilless-cartridge-assembly 1400 is operatively assembled, detonation assembly 1400 embraces bullet casing 824 of cartridge 820.

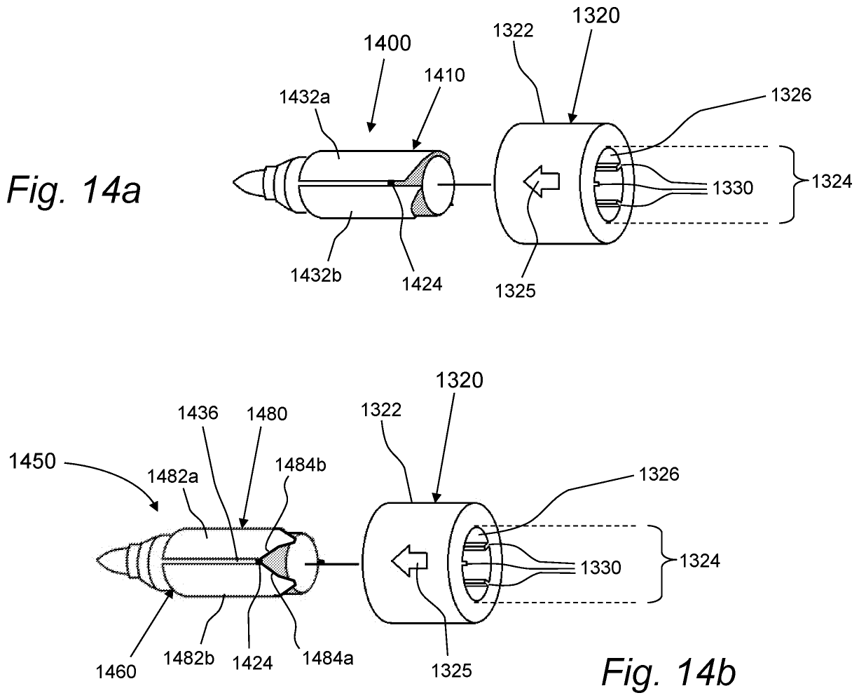

Reference is now also made to FIG. 14a, illustrating a ribbed bolt-hammering-unit 1320 moving linearly forward with respect to the respective firearm, in direction 1325, towards recoilless-cartridge-assembly 1400. The diameter of opening 1324 of ribbed bolt-hammering-unit 1320 is fittingly larger than the external diameter of cylindrical-envelope 1430. When at the rear ends of recoilless-cartridge-assembly 1400, directing ribs 1330 meet the sloped rear ends 1434 of the respective peripheral segment 1432, causing detonation assembly 1410 (or optionally, the whole of recoilless-cartridge-assembly 1400) to pivot until each of the directing ribs 1330 meet the respective slit 1436, and continues to move forward until meeting the end of the respective wing 1424. At this point, if recoilless-cartridge-assembly 1400 is in position at the cartridge-chamber of a firearm, firing pin 1420 is pushed forward to thereby, when pin 1426 pecks primer 826 of cartridge assembly 820, and the firing and detonation sequences begin. It should be appreciated that relative pivotal motion between the ribbed bolt-hammering-unit 1320 and the detonation assembly 1410 can be performed by the recoilless cartridge-assembly 1400, the ribbed bolt-hammering-unit 1320 or a combination thereof. It should be further appreciated that relative pivotal motion between the ribbed bolt-hammering-unit 1320 and the detonation assembly 1410 can be performed by other mechanisms, for example, each sloped rear end 1434 of a respective peripheral segment 1432 can be replaced by two slopes, each configured to create a pivotal motion of detonation assembly 1410 in opposite pivotal direction and shortening the pivotal step.

Reference is also made to FIG. 14b, illustrating a ribbed bolt-hammering-unit 1320 moving linearly forward with respect to the respective firearm, in direction 1325, towards another variation of another recoilless-cartridge-assembly 1450, according to aspects of the present disclosure. Recoilless-cartridge-assembly 1450 includes a standard cartridge, such as cartridge 520/820, and a detonation assembly add-on 1450, adapted to fit onto standard cartridge 820.

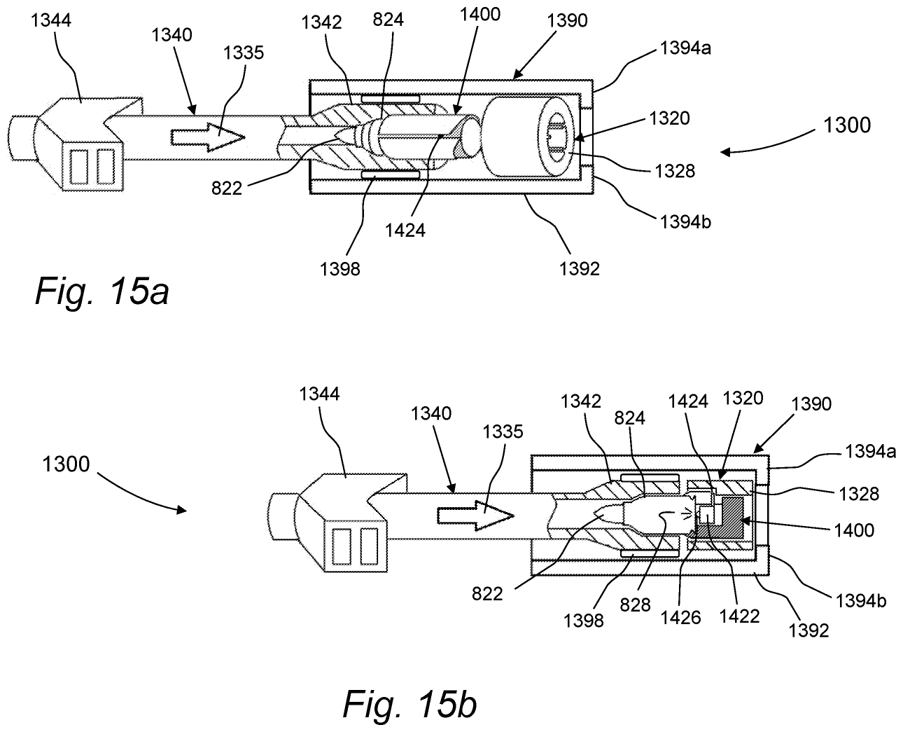

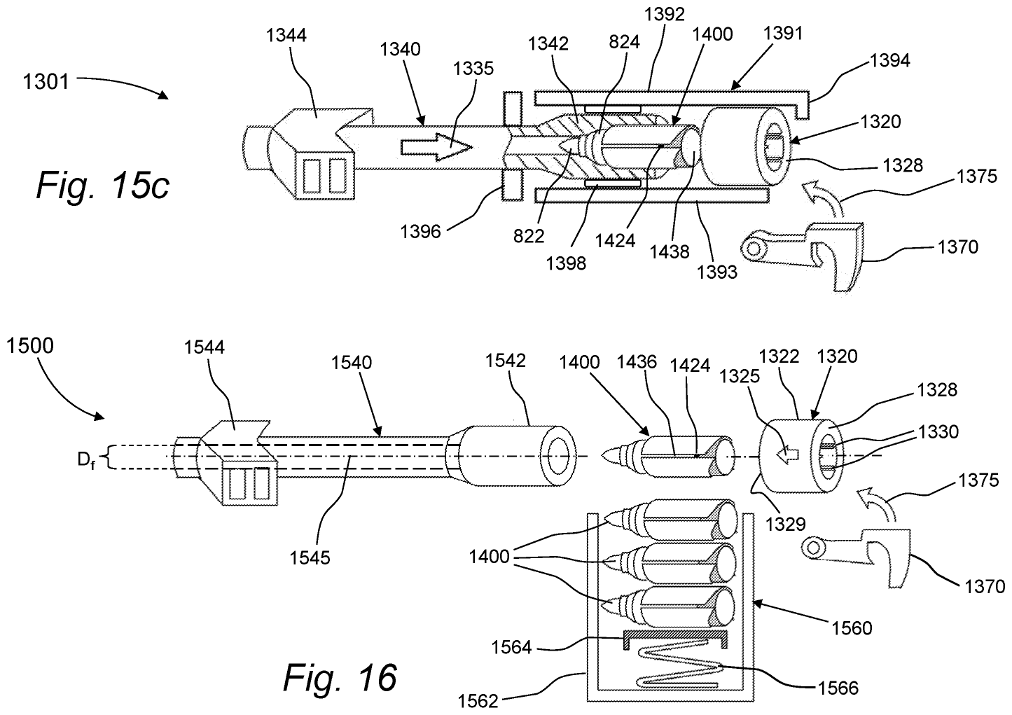

Generally, detonation assembly 1450 is similar to detonation assembly 1400, except for the rear end 1484 of each peripheral segment 1482, that correspond the rear end 1434 of each peripheral segment 1432, respectively. While the sloped rear end of each peripheral segment 1432 leads towards a single slit 1436, each peripheral segment 1482 has two sloped ends 1484a and 1484b, wherein each sloped end 1484 leads towards a neighboring slit 1436. Therefore, in this case, the number of sloped ends 1484 is twice the number of slit 1436. Reference is now also made to FIG. 15a that illustrates a blow-forward type firearm 1300 that includes a barrel unit 1340 and a bolt assembly 1390, according to aspects of the present disclosure. Bolt assembly 1390 includes a ribbed bolt-hammering-unit 1320 as described hereabove, wherein ribbed bolt-hammering-unit 1320, is configured to facilitate the pecking by firing pin 1426 of the primer 826 of cartridge assembly 820, and thereby initiate the firing and detonation sequences, as described here above.

Bolt assembly 1390 is coupled to operate with a barrel unit 1340 using another example usage of a unidirectional energy transfer mechanism, according to aspects of the present disclosure. Firearm 1300 is configured to fire bullet 822 of a recoilless-cartridge-assembly 1400, as described here above. However, being a blow-forward type firearm and having a recoilless-cartridge-assembly 1400 disposed in its cartridge-chamber 1342, firearm 1300 is configured to activate the firing sequence when moving the barrel unit 1340 of firearm 1300 backwards, in direction 1335. It should be appreciated that mechanisms for moving the barrel unit 1340 of firearm 1300 backwards using a biasing element, such as a spring, are well known in the art.

Bolt assembly 1390 further includes a piped limiter 1392 that is engaged to move linearly with respect to barrel unit 1340, upon a bearing mechanism 1398. Situated at a forward section of piped limiter 1392. Piped limiter 1392 is configured to allow insertion of a recoilless-cartridge-assembly 1400 into the cartridge-chamber of firearm 1300. Piped limiter 1392 is further configured to accommodate ribbed bolt-hammering-unit 1320. Piped limiter 1392 further includes, at the rear end of piped limiter 1392, bolt-stoppers 1394, preventing ribbed bolt-hammering-unit 1320 from escaping piped limiter 1392, when moving backwards.

When barrel unit 1340 of firearm 1300 moves backwards, in direction 1335, bearing mechanism 1398 allows free linear motion of piped limiter 1392 with respect to barrel unit 1340. As recoilless-cartridge-assembly 1400 meets ribbed bolt-hammering-unit 1320, wherein barrel unit 1340, recoilless-cartridge-assembly 1400 and ribbed bolt-hammering-unit 1320 continue to move backwards until ribbed bolt-hammering-unit 1320 is stopped by bolt-stoppers 1394. While

Next, as barrel unit 1340 continuous to push backwards, directing ribs 1330 meet the sloped rear ends 1434 of the respective peripheral segment 1432, causing recoilless-cartridge-assembly 1400 to pivot until each of the directing ribs 1330 meet and enter the respective slit 1436, and recoilless-cartridge-assembly 1400 continues to move backwards until meeting the end of the respective wing 1424. At this point, recoilless-cartridge-assembly 1400 continues to move backwards, however, the ends of the wing 1424 remain stuck at the front-end-face 1329 (see FIG. 12) of ribbed bolt-hammering-unit 1320. Therefore, primer 826 of cartridge assembly 820 continuous to move towards firing pin 1420 until pin 1426 pecks primer 826, as illustrated in a partial cross section view of FIG. 15b, and the firing and detonation (828) sequences begin.

At this stage, the propellant gasses formed at the detonation (828) also push cartridge casing 824 in direction 1335, along with detonation assembly 1410. The ends of wings 1424 are deformed or broken, and cartridge casing 824, firing pin 1420 and detonation assembly 1410 proceed to move backwards, wherein slit 1436 slide over the respective directing ribs 1330 and then through opening 1324 (see FIG. 14) of ribbed bolt-hammering-unit 1320, until completely ejecting out of firearm 1300.

It should be noted that motion limiters, including linear motion limiters and rotational motion limiters may take a variety of forms, as known in the art.

Reference is now also made to FIG. 15c that illustrates a blow-forward type firearm 1301 that includes a barrel unit 1340 and a bolt assembly 1391, according to other aspects of the present disclosure. Firearm 1301 is quite similar to firearm 1300, except that when moving the barrel unit 1340 of firearm 1300 backwards, firearm 1300 goes to a cocked state, while the recoilless cartridge assembly 1400 and the ribbed bolt-hammering unit 1320 rotate one with respect to the other, until reaching a cocked position and ready to be fired. Then, an additional mechanism 1310, as described with respect to FIG. 12, is activated to provide ribbed bolt-hammering-unit 1320 with a forward thrust by a hammer 1370. In this example embodiment, piped limiter 1392 is adapted to allow hammer 1370 to hit ribbed bolt-hammering-unit 1320. In this example embodiment, bolt assembly 1390 further includes barrel stopper 1396 to block barrel unit 1340 from impacting pin 1426 of firing pin 1420, while moving backwards.

According to aspects of the present disclosure, there is provided an example firearm system 1500, as illustrated in FIG. 16, that utilizes the methodology of firearm assembly and methodology 1310 using recoilless-cartridge-assembly 1400. Firearm system 1500 includes a barrel 1540 having an inner-barrel-diameter and a cartridge-chamber 1542, at least one recoilless-cartridge-assembly 1400 and a piped bolt-hammering-unit 1320.

Optionally, firearm system 1500 further includes a magazine 1560, adapted to hold a number of recoilless-cartridge-assemblies 1400, for automatic and semi-automatic firearms. In such embodiments, and other embodiments, respective multiple disposable firing pins 1420. Firearm system 1500 can further include a ribbed bolt-hammering unit 1320 that is used as a part of the feeding mechanism that operatively interacts with magazine 1560. Ribbed bolt-hammering unit 1320 extracts a recoilless-cartridge-assembly 1400, that is next in line, from magazine 1560 and loads the extracted recoilless-cartridge-assembly 1400 into cartridge-chamber 1542 of barrel 1540.

Upon the extracted recoilless-cartridge-assembly 1400 entering into chamber 1542, the ribbed bolt-hammering-unit 1320 continues to move forward towards recoilless-cartridge-assembly 1400, and thereby directing ribs 1330 meet the sloped rear ends 1434 of the respective peripheral segment 1432, causing recoilless-cartridge-assembly 1400 to pivot until each of the directing ribs 1330 meet and enter the respective slit 1436, and then continue and meet the ends of wing 1424, via the front-end-face 1329 of ribbed bolt-hammering-unit 1320. Upon cartridge 820, being blocked inside the cartridge-chamber 1542, ribbed bolt-hammering-unit 1320 continuous the move forward, pushing firing pin 1420 forward towards primer 826 of cartridge assembly 820, until reaching their cocked position within predefined safety distance of the firing pin 1420 from the primer 826, resting in the cocked position, being in a cocked state, ready to be fired.

When firearm system 1500 is triggered, a hammer mechanism, for example mechanism 1370 hammers the rear face 1328 of ribbed bolt-hammering-unit 1320 that thereby moves forward, to direction 1325, according to the methodology described with respect to methodology 1310 (see FIG. 12). The hammering energy is then transferred to firing pin 1420, wherein the tip of firing pin 1426 pecks the primer 826 of cartridge assembly 820, and the firing sequence begins, including the bending of wings 1424 of firing pin 1420 and including both firing pin 1420 and bullet casing 824, that absorb the energy of the recoil are flown out through the inner opening 1324 of ribbed bolt-hammering-unit 1320, out of the rear of firearm system 1500.

It should be appreciated that firearms 1200, 1300 (and 1301), and 1500 are preconfigured to the have primary cartridge 520 generate a recoil force 525 (Fₚ) that is higher than the counter resistance (Fᵣ) formed by weight of the bullet casing 824 the weight of firing pin 1420 (and 910) and the resistance to deform/brake of pin-wing(s) 916, 1256 and 1424, such that: ΔF=Fₚ, −Fᵣ. Hence, similar to muzzle-brakes 640 and 740, the difference in these forces ΔF is compensated using an additional recoil compensation element—a muzzle-brake 1244, 1344, and 1544, respectively.

It should be further appreciated that the resistance of pin-wing(s) to deform/brake, can be predesigned by selecting preconfigured materials for the various parts of the respective firing-pin. Hence, when applying an excess force (Fₑ) onto the pin-wing(s) (916, 1256 and 1424), the pin-wing(s) deforms or breaks.

The invention being thus described in terms of several embodiments and examples, it will be obvious that the same may be varied in many ways. Such variations are not to be regarded as a departure from the spirit and scope of the invention, and all such modifications as would be obvious to one skilled in the art.

1-37. (canceled)

38. A recoilless firearm apparatus for firing at least one bullet of a respective standard cartridge having a standard caliber, comprising:
a) a front barrel having an inner-barrel-diameter and a rear cartridge-chamber having a rear cartridge-chamber diameter configured to receive the standard cartridge;
b) a disposable firing activator; and
c) a rear discharge opening formed behind said front barrel, aligned with the longitudinal axis of said front barrel;
wherein the standard cartridge further includes a casing having an external diameter that is smaller than said rear cartridge-chamber diameter, wherein the casing encloses a sealed inner-casing space that contains gunpowder, and wherein the casing includes a primer; and
wherein upon activating the primer, the primer explodes to thereby detonate the gunpowder, forming propellant gasses inside the cartridge that are directed both forward and backward as follows:
a) forward: firing of the bullet via said front barrel; and
b) backward: pushing, by a recoil force Fₚ, the casing, being a counterweight to the bullet, to thereby eject the casing from the firearm apparatus via said rear discharge opening.

39. The recoilless firearm apparatus of claim 38, wherein
(i) said disposable firing activator is an electric contact configured to transfer electric power from a side located electrode to the primer to thereby activate the primer, and wherein said disposable firing activator is ejected with the casing from the firearm apparatus via said rear discharge opening, or
(ii) said disposable firing activator is a firing pin, wherein said activating of the primer is performed by said firing pin hitting the primer, and wherein said disposable firing pin is ejected with the casing from the firearm apparatus via said rear discharge opening, or
(iii) upon said activating of the primer by said pin of said disposable firing pin, the formed propellant gasses push the casing and said disposable firing pin backwards by the recoil force Fₚ, where Fₚ>>Fₑ, thereby upon said pin-wings hitting said bolt-front-face of said piped bolt-hammering-unit, said pin-wings deform or break, and thereby, the casing and said deformed disposable firing pin continue to move through said bolt-inner-opening and eject from the firearm apparatus via said rear discharge opening, or
(iv) further comprising a recoil compensator that is securely attached to said front barrel, adapted to operatively compensate for the difference in forces ΔF, between a recoil force Fₚ, and the sum of said excess force Fₑ, the weight of the casing and all parts of said firing-pin, or
(v) further comprises a recoil-prevention mechanism, wherein said recoil-prevention mechanism comprises:
a) a rear barrel having said rear discharge opening; and
b) a dual-cartridge firearm magazine, configured to receive said standard cartridge, and a counterweight having a primer activator,
wherein said standard cartridge and said counterweight are arranged in a back-to-back configuration;
wherein said primer activator is operatively placed between said primer of said primary cartridge and said counterweight, such that said primer activator is aligned with said primer of said primary cartridge;
wherein the bullet of said primary cartridge is configured to be fired via said front barrel and said casing and said counterweight is configured to be fired via said rear barrel; and
wherein upon detonation of said primary cartridge, the generated recoil force pushes the casing and said counterweight rearwardly, to thereby eject the casing and said counterweight from the firearm apparatus via said rear discharge opening, or
(vi) said dual-cartridge firearm magazine is an electronic dual-cartridge firearm magazine having a high voltage module, wherein said primary cartridge is a combat cartridge and said counterweight is an electronic cartridge, wherein said electronic cartridge comprises:
a) a built-in, electric ignition circuit;
b) an electronic ignition heater;
c) a secondary casing;
d) gunpowder;
e) a firing activation unit; and
f) a sealing unit configured to seal the rear side of said electronic cartridge, wherein said sealing unit also serves as a counterweight,
wherein upon receiving an electronic ignition trigger by said high voltage module, said dual-ignition electric circuit is activated to thereby turn on said electronic ignition heater and thereby:
a) detonating the gunpowder disposed inside said electronic cartridge;
b) shifting forward of said electronic cartridge towards said primary casing;
c) detonating said primary primer by said firing activation unit;
d) firing of said primary bullet via said front barrel;
e) ejecting said counterweight via said rear barrel, or
(vii) said sealing unit and said propellant gasses serve as a counterweight to the weight of said primary bullet, or
(viii) a hovering firearm system, comprising:
a) the hovering subsystem configured to lift a recoilless firearm apparatus to the air and fly towards a designated target; and
b) a mounting platform,
wherein said recoilless firearm is securely attached to said mounting platform; and
wherein upon firing said at least one bullet, the remaining residual recoil force allows the hovering firearm system to continue a controlled flight.

40. The recoilless firearm apparatus of claim 39, part (ii), wherein
(1) said disposable firing-pin comprises:
a) a pin-body having a body having a pin-front-end, being an open end, and a pin-rear-end;
b) a pin disposed at said pin-front-end; and
c) at least one pin-wing disposed at said pin-rear-end,
wherein when in a cocked state, said standard cartridge rear is seated inside said cartridge-chamber and said pin is positioned in safe proximity to the primer;
wherein said firing pin is made of rigid materials; and
wherein the parts of said firing-pin, including said at least one pin-wing, are made of deformable or breakable materials, such that when applying an excess force Fₑ onto said at least one pin-wing, said at least one pin-wing deforms or breaks, or
(2) said disposable firing-pin comprises:
a) a pin-body having a body having a pin-front-end, being an open end, a frontal-body-section and a rear-body-section having a pin-rear-end with a larger diameter end; and
b) a pin disposed at said pin-front-end,
wherein said larger diameter of said pin-rear-end is configured to seal said rear discharge opening;
wherein when in a cocked state, said standard cartridge rear is seated inside said cartridge-chamber and said pin is positioned in safe proximity to the primer;
wherein said firing pin is made of rigid materials; and
wherein at least said rear-body-section, including said larger diameter end, is made of deformable or breakable materials, such that when applying an excess force Fₑ onto said firing pin, said firing pin deforms or breaks.

41. The recoilless firearm apparatus of claim 40, part (1), further comprising
(A) a piped bolt-hammering-unit, having a bolt-front-face and a bolt-rear-face, and comprises a body having a bolt-inner-opening formed there within, wherein said bolt-inner-opening is larger than the external diameter of the casing, allowing free longitudinal motion of the casing there inside;
wherein said pin-wings have a wing-span that is larger than said bolt-inner-opening;
wherein when the firearm is in a cocked state, said bolt-front-face is positioned in safe proximity to said pin-wings; and
wherein said activating of the primer is performed by applying a unidirectional forward force on said piped bolt-hammering-unit that pushes forward said disposable firing pin and, thereby, said pin activates of the primer, or
(B):
a) a recoilless-cartridge-assembly, comprising:
i. a standard cartridge being a primary cartridge unit having a primary casing; and
ii. a detonation assembly comprising:
A. a cylindrical-envelope having an inner diameter, an external diameter, a front end and a rear end, wherein the front end operatively faces said front barrel;
B. a rear plug, wherein said rear plug securely encloses said inner diameter of said rear end of said cylindrical-envelope; and
C. a disposable firing pin comprising:
I. a pin-body;
II. at least one wing having a wing-span diameter, wherein said wing-span diameter is larger than said inner diameter of said cylindrical-envelope; and
III. a pin,
wherein at least one through slits is formed in said cylindrical-envelope, one said slit for each said respective wing;
wherein each of said slit extends from said front end of said cylindrical-envelope to said rear end of said cylindrical-envelope;
wherein said slits segment said cylindrical-envelope into separate peripheral segments;
wherein the rear end of each of said peripheral segment is sloped, starting at a first rear corner at each of said peripheral segment, and ending at the other corner of that peripheral segment, and at a predesigned distance from the rear end of said rear plug, and wherein said corner is formed by said sloped peripheral segment and a bank of the respective slit;
wherein, when said detonation assembly is operatively assembled, each said slit accommodates the open end of a respective said wing; and
wherein, when said recoilless-cartridge-assembly is operatively assembled, said detonation assembly embraces said primary casing of said primary cartridge unit;
b) a ribbed bolt-hammering-unit comprising:
i. a piped body comprising:
A. an inner base-opening forming an inner wall;
B. a front face; and
C. a rear face;
ii. at least one directing rib protruding inwardly from said inner wall of said inner base-opening, at a preconfigured location, wherein said at least one directing rib is adapted to operatively engage with the open end of a respective said at least one wing; and
c) a unidirectional energy transfer mechanism, wherein
the number of said peripheral segments, the number of said wings, the number of said slits and the number of said directing ribs are equal;
said bolt-inner-opening is defined by the tips of said directing ribs;
said unidirectional energy transfer mechanism is configured to allow said bolt-hammering-unit to move forward freely, and to controllably block said bolt-hammering-unit from moving backward;
said unidirectional energy transfer mechanism is adapted to apply said forward motion of said bolt-hammering-unit;
while moving forward, when each of said directing ribs of said bolt-hammering-unit meets said sloped rear ends of a respective said peripheral segment, the method further comprises the steps of:
a) pivoting said detonation assembly until reaching said respective slits;
b) entering said respective slits until meeting said open end of each of said respective wings that stick out of said cylindrical-envelope; and
c) pushing said firing pin forward towards said primary primer,
wherein upon reaching the primer of said standard cartridge, being disposed inside said rear cartridge-chamber in a cocked state, said pin impacts said primer to thereby causing said primer explosion and detonation of the gunpowder inside the casing, or
(C):
a) a piped bolt-hammering-unit comprising:
i. a piped body comprising:
A. a bolt-inner-opening, wherein said at least one wing has a wing-span diameter, and wherein said wing-span diameter is larger than said inner diameter of said piped body;
B. an external diameter;
C. a bolt-front-face; and
D. a bolt-rear-face;
ii. at least one groove formed in said front face, wherein said at least one groove is adapted to respectively accommodate said at least one wing; and
b) a unidirectional energy transfer, being a motion limiting mechanism, wherein said unidirectional energy transfer is configured to allow said piped hammering-unit to move forward freely, and to controllably block said piped hammering-unit from moving backward;
wherein said unidirectional energy transfer or motion limiting mechanism is adapted to apply said forward motion of said piped hammering-unit;
wherein, while moving forward, said piped hammering-unit is configured to collect said disposable firing-pin, and wherein said at least one wings is seated inside said at least one groove, respectively; and
wherein upon reaching said primary cartridge, being in a cocked state, said pin impacts said primary primer of said primary cartridge to thereby detonate the gunpowder inside said primary casing, forming propellant gasses that are directed forward and backward as follows:
a) forward:
i. firing of said primary bullet via said front barrel; and
b) backward:
i. pushing said primary casing and disposable firing pin backward;
ii. deforming said at least one wing of said disposable firing pin into said inner opening of said piped hammering-unit; and
iii. ejecting said primary casing and said disposable firing pin via said inner opening of said piped hammering-unit, while said unidirectional energy transfer mechanism prevents said piped hammering-unit from moving backward.

42. The recoilless firearm apparatus of claim 41, part (B), wherein
(a) the rear end of each of said sloped peripheral segment include two slopes, each leading towards a respective neighboring slit, or
(b) said unidirectional energy transfer mechanism controls the motion of said bolt-hammering-unit, and wherein said motion is a linear motion, a rotational motion or a combination thereof.

43. The recoilless firearm apparatus of claim 38, part (iv), wherein said recoil compensator is a muzzle-brake or a jet nozzle.

44. The recoilless firearm apparatus of claim 41, part (B), wherein said disposable firing pin is provided by a band magazine, and wherein a respective said firing pin is dispatched from said band magazine by said moving forward piped hammering-unit.

45. The hovering firearm system of claim 39, part (vi), wherein
(1) said platform comprises a first gimbal having a carrying face, and wherein said recoilless firearm apparatus is mounted on said first gimbal, or
(2) further comprising an electro-optical module having a camera, wherein said camera has an optical line of sight aimed to the target.

46. The hovering firearm system of claim 45, part (2), wherein
(a) said electro-optical module is attached to said first gimbal, or
(b) further comprising a second gimbal, wherein said electro-optical module is attached to said second gimbal, wherein
(i) said second gimbal is independent of said first gimbal, or
(ii) said second gimbal is mounted on said first gimbal.

47. The hovering firearm system of claim 46, wherein said optical line of sight is controllably aligned with said recoilless firearm to thereby facilitate sequential shootings at the target without losing said boresight.

48. The hovering firearm system of claim 47, wherein
(i) said aligning of said optical line of sight boresight (boresighting) is either mechanical alignment or electronic boresighting utilizing shift or image crosser motion, or
(ii) said boresighting is updated in real-time using ballistic calculations, wind vector calculations or a combination thereof.

49. The hovering firearm system of claim 48, part (i), wherein said boresighting comprises locking of said line of sight on the target, and controllably aligning the longitudinal axis of said front barrel with said optical line of sight of said camera.

50. A recoilless firearm apparatus for bidirectional recoilless firing at least one bullet of a respective standard cartridge having a standard caliber, comprising:
a) a front barrel having an inner-barrel-diameter and a rear cartridge-chamber having a rear cartridge-chamber diameter configured to receive the standard cartridge;
b) a disposable firing activator;
c) a recoil-prevention mechanism comprising:
i. a rear barrel having said rear discharge opening; and
ii. a dual-cartridge firearm magazine, configured to receive said standard cartridge, being a primary cartridge, a secondary cartridge, and a dual firing pin unit having a primary pin and a secondary pin, wherein said secondary cartridge includes a secondary sealed casing, including:
A. gunpowder; and
B. a secondary primer,
wherein said primary cartridge and said secondary cartridge are arranged in a back-to-back configuration;
wherein said dual firing pin unit is operatively placed between said primer of said primary cartridge and said secondary primer, such that said primary pin is aligned with said primer of said primary cartridge and said secondary pin is aligned with said secondary primer;
wherein the bullet of said primary cartridge is configured to be fired via said front barrel and said secondary cartridge is configured to be fired via said rear barrel; and
wherein upon simultaneous detonation of said primary cartridge and, the recoil force generated by said secondary cartridge cancels the recoil force generated by said primary cartridge.

51. The recoilless firearm apparatus of claim 50, wherein
(i) said primary cartridge and said secondary cartridge are of identical type;
said front barrel and said rear barrel are not equal in length; and
upon simultaneous detonation of said primary cartridge and, the recoil force generated by said secondary cartridge cancels the recoil force generated by said primary cartridge, or
(ii) said primary cartridge and said secondary cartridge are not of identical type;
said front barrel and said rear barrel are not equal in length;
upon simultaneous detonation of said primary cartridge, the recoil force generated by said secondary cartridge cancels the recoil force generated by said primary cartridge; and
said recoil-prevention mechanism further comprises a recoil compensator, to thereby compensate for inequalities between the recoil forces generated by said primary cartridge and said secondary cartridge, or
(iii) said primary cartridge is a combat cartridge and said secondary cartridge is a dummy cartridge.

52. The recoilless firearm apparatus of claim 51, part (i), wherein said recoil-prevention mechanism further comprises a recoil compensator, to thereby compensate for inequalities between the recoil forces generated by said primary cartridge and said secondary cartridge.

53. The recoilless firearm apparatus of claim 52, wherein said recoil compensator is a muzzle-brake or a jet nozzle.

54. A recoilless-cartridge-assembly comprising:
1) a standard cartridge; and
2) a detonation assembly comprising:
a cylindrical-envelope having an inner diameter, an external diameter, a front end and a rear end, wherein the front end operatively faces said front barrel;
a rear plug, wherein said rear plug securely encloses said inner diameter of said rear end of said cylindrical-envelope; and
a disposable firing pin comprising:
a pin-body;
at least one wing having a wing-span diameter, wherein said wing-span diameter is larger than said inner diameter of said cylindrical-envelope; and
a pin,
wherein at least one through slits is formed in said cylindrical-envelope, one said slit for each said respective wing;
wherein each said slit extends from said front end of said cylindrical-envelope to said rear end of said cylindrical-envelope; and
wherein said slits segment said cylindrical-envelope into separate peripheral segments.

55. The recoilless-cartridge-assembly of claim 54,
wherein the rear end of each said peripheral segment is sloped, starting at a first rear corner at of each said peripheral segments, and ending at the other corner of that peripheral segment and at a predesigned distance from the rear end of said rear plug, and wherein said corner is formed by said sloped peripheral segment and a bank of the respective slit;
wherein, when said detonation assembly is operatively assembled, each said slit accommodates the open end of a respective said wing; and
wherein, when said recoilless-cartridge-assembly is operatively assembled, said detonation assembly embraces said primary casing of said primary cartridge unit.

56. The recoilless-cartridge-assembly of claim 55, wherein the rear end of each of said sloped peripheral segment include two slopes, each leading towards a respective neighboring slit.
